(19) United States
(12) Patent Application Publication
(10) Pub. No.: US 2019/0188154 A1
(43) Pub. Date: Jun. 20, 2019

(54) TRANSLATION PINNING IN TRANSLATION LOOKASIDE BUFFERS

(71) Applicant: Intel Corporation, Santa Clara, CA (US)

(72) Inventors: Rangeen Basu Roy Chowdhury, Santa Clara, CA (US); Hussein Elnawawy, Raleigh, NC (US); Amro Awad, Orlando, FL (US)

(21) Appl. No.: 15/843,165

(22) Filed: Dec. 15, 2017

(51) Int. Cl. G06F 12/126; G06F 12/1027; G06F 12/1018; G06F 9/30; G06F 9/50; G06F 9/455

(52) U.S. Cl. CPC G06F 12/126; G06F 12/1027; G06F 12/1018; G06F 2212/684; G06F 9/5016; G06F 2009/45583; G06F 9/3004

(57) ABSTRACT

A processor includes a first translation lookaside buffer (TLB), a second TLB, and a TLB control mechanism. The TLB control mechanism is to store a TLB-miss count (TMC) for a page. The TMC indicates a number of TLB misses of the first TLB for the page. The TLB control mechanism is further to determine that the TMC is greater than a threshold count and store a translation of the page in the second TLB responsive to a determination that the TMC is greater than the threshold count.

### BACKGROUND

Physical memory may be allocated with page granularity and processes may use virtual addresses to access the allocated pages. Mappings of virtual-to-physical addresses are known as translations. A processor may include a translation lookaside buffer (TLB) that stores translations. Upon receiving a data request including a virtual address, the processor may determine whether a translation corresponding to the virtual address is located in the TLB. If the translation is located in the TLB (a TLB hit), the processor may determine the physical address corresponding to the virtual address based on the translation. If the translation is not located in the TLB (a TLB miss), the processor may determine the physical address via a process that is more time consuming than determining the physical address from a translation located in the TLB.

### BRIEF DESCRIPTION OF THE DRAWINGS

FIG. 1A illustrates a system including a TLB control mechanism, a pinned TLB (PTLB) control mechanism, a TLB, and a PTLB, according to one embodiment.

FIG. 1B illustrates a system including an L1-TLB control mechanism, an L1-TLB, an L1-PTLB control mechanism, an L1-PTLB, an L2-TLB control mechanism, an L2-TLB, an L2-PTLB control mechanism, and an L2-PTLB, according to one embodiment.

FIG. 1C illustrates a system including an L1-TLB, an L1-PTLB control mechanism, an L1-PTLB, an L2-TLB, an L2-PTLB control mechanism, and an L2-PTLB, according to one embodiment.

FIG. 2 is a flow diagram of a method of storing a translation of a page in a PTLB, according to one embodiment.

FIG. 3 illustrates a page table organization with a shadow counter table, according to one embodiment.

FIG. 4A is a bar graph illustrating execution time speedup normalized to base (no pinned TLBs) of a unified TLB-miss count (TMC) model and a separate TMC model, according to one embodiment.

FIG. 4B is a bar graph illustrating execution time speedup normalized to base (no pinned TLBs) for different benchmarks and for different storage styles of TLB-miss counters, according to one embodiment.

FIG. 4C is a bar graph illustrating relative miss rate normalized to base (no pinned TLBs) for different benchmarks and for different storage styles of TLB-miss counters, according to one embodiment.

FIG. 4D is a bar graph illustrating execution time speedup normalized to base (no pinned TLBs) for different sizes and different benchmarks and for different storage styles and sizes of TLB-miss counters, according to one embodiment.

FIG. 4E is a bar graph illustrating relative miss rate normalized to base (no pinned TLBs) for different sizes and different benchmarks and for different storage styles and sizes of TLB-miss counters, according to one embodiment.

FIG. 4F is a bar graph illustrating power consumption normalized to base (no pinned TLBs) for different benchmarks, according to one embodiment.

FIG. 5 is a block diagram illustrating a micro-architecture for a processor that includes the PTLB control mechanism and the PTLB, according to one embodiment.

FIG. 6 illustrates a block diagram of the micro-architecture for a processor that includes the PTLB control mechanism and the PTLB, according to one embodiment.

FIG. 7 is a block diagram of a computer system according to one embodiment.

FIG. 8 is a block diagram of a computer system according to another embodiment.

FIG. 9 is a block diagram of a system-on-a-chip according to one embodiment.

FIG. 10 illustrates another embodiment of a block diagram for a computing system.

FIG. 11 illustrates another embodiment of a block diagram for a computing system.

### DESCRIPTION OF THE EMBODIMENTS

With the ever-increasing sizes of application datasets and the emergence of memory-intensive workloads, use of virtual memory is dramatically increasing. Physical memory may be allocated (e.g., by the operating system (OS)) with page granularity and processes may use virtual address to access the allocated pages. The OS may manage the mappings (e.g., translations) of virtual-to-physical addresses. Virtualization of physical memory may give each process the illusion that the process owns the entire memory space (e.g., relieves the program from the complexity of explicitly managing physical memory such as free list, backing store, etc.). Virtualization of physical memory may provide memory protection (e.g., otherwise programs may corrupt the memory intentionally or unintentionally via bad pointers, malicious code, etc.). Virtualization of physical memory may provide security (e.g., isolation between processes, no process has access to another process's data). Virtualization allows performance and memory capacity optimizations such as Copy-on-Write (CoW) and memory deduplication. Virtualization provides flexibility of memory management and may enable systems (e.g., systems with different processor sockets, Non-Uniform Memory Access (NUMA) systems, multi-level memory (MLM) composed of different memory technologies) to manage physical memory at a fine-granularity (e.g., 4 KB).

Use of virtual memory includes translating a virtual address to a corresponding physical address before accessing the cache and hierarchy of physical memory. The translation is time sensitive and can be a source of program execution slowdown. Consequently, virtual memory embodiments may include hardware support for virtual memory, such as a Memory Management Unit (MMU). The MMU may include a unit called a translation lookaside buffer (TLB). It should be noted that TLBs, as well as the embodiments described herein, can be used outside the context of a MMU.

An MMU may receive a data request including a virtual address and may determine whether a translation corresponding to the virtual address is located in the TLB. A TLB miss occurs when the translation is not in the TLB and a TLB hit occurs when the translation is in the TLB. A TLB insert or fill occurs when a new translation replaces an existing translation in the TLB based on a replacement policy. A traditional replacement policy is the Last recently used (LRU) policy where the translation (e.g., TLB entry) that has not been used the longest amount of time is evicted from the TLB in order for a new translation to be stored in the TLB.

The TLB may be a fast caching structure to cache virtual memory translations. The performance of the TLB has an impact on the overall system of performance and power consumption of the processor since memory accesses (e.g., fetching instructions) include accessing the TLB before proceeding. Accordingly, TLBs are implemented to be extremely fast. Since TLB latency impacts processor performance and power consumption, conventional TLBs are designed to be small (e.g., L1-TLB size may be 32-64 entries). The memory reach for conventional TLB sizes (e.g., 32-64 entries) may not keep up with demands of conventional workloads which leads to MMU performance overhead (e.g., MMU performance overhead in the range of 5-50%).

In different workloads (e.g., graph analytics, sparse matrix multiplication, in-memory key-value stores, etc.), a large percentage of TLB misses may be caused by accesses to a tiny fraction of the overall accessed memory pages. For example, under traditional replacement policies, 1.5% of the accessed memory pages may cause 45% of the TLB misses. Such page-translation miss heterogeneity is difficult to detect through conventional replacement policies since the pages may be repeatedly accessed but with high reuse distances (e.g., a few pages may have high reuse but poor temporal locality). For example, an LRU policy with an associativity of 4 will not be able to keep a translation of page A in the TLB for the following repeating pattern of page accesses: 1 2 3 4 A 5 6 7 8 A 9 10 11 12 A 13 14 15 16 A . . . and so on. Page A shows heterogeneity compared to other pages. Page A is used often but has a reuse distance of 5, so an LRU policy with an associativity of 4 cannot keep a translation of page A in the TLB.

Described herein are embodiments of TLB-miss heterogeneity-aware TLB technology. A TLB-miss heterogeneity-aware TLB design, as described in embodiments herein, presents a solution to the above-mentioned and other challenges. The TLB-miss heterogeneity-aware TLB design may include a pinned TLB (PTLB) which may be a second TLB that uses a second policy different than a first policy of a first TLB. A PTLB control mechanism may identify reuse behavior of pages and may pin, in the PTLB, the pages that are expected to be reused later. Use of a PTLB may improve performance for different workloads compared to use of a TLB without a PTLB. The PTLB control mechanism may identify highly accessed pages through tracking the number of TLB misses per page, which may be used for pinning decisions. If a page translation is expected to be reused beyond the temporal reuse distance of TLB associativity, the PTLB control mechanism may pin the translation for an adjustable amount of time in the PTLB. The PTLB control mechanism may control the pinning period through dynamic adjustment that accounts for recent behavior of the translation. The PTLB may be naturally extended for software-pinning in which the application or the operating system (OS) provides an indication to the TLB that a translation is to be pinned (e.g., hints a desire to pin the translation) for a specific page or a range of pages. The indication may be relayed to the TLB through special bits in Page Table Entries (PTEs). In some embodiments, the TLB and PTLB are implemented in a MMU. Alternatively, the TLB and PTLB are implemented in other configurations outside of the MMU or in configurations without an MMU.

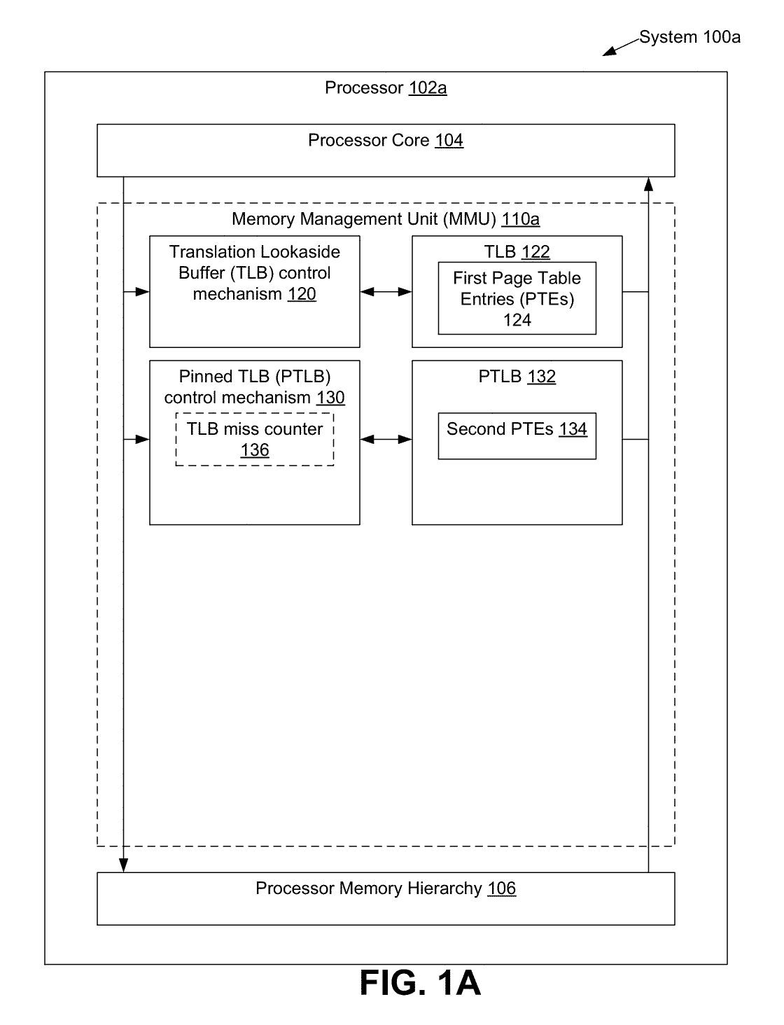

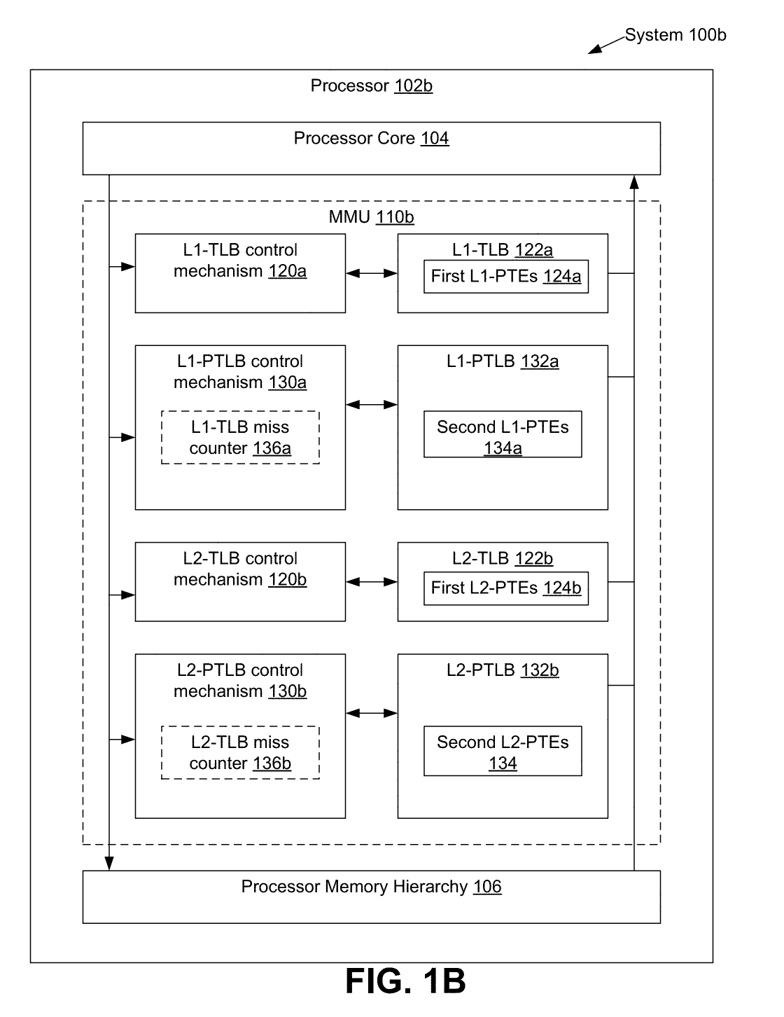

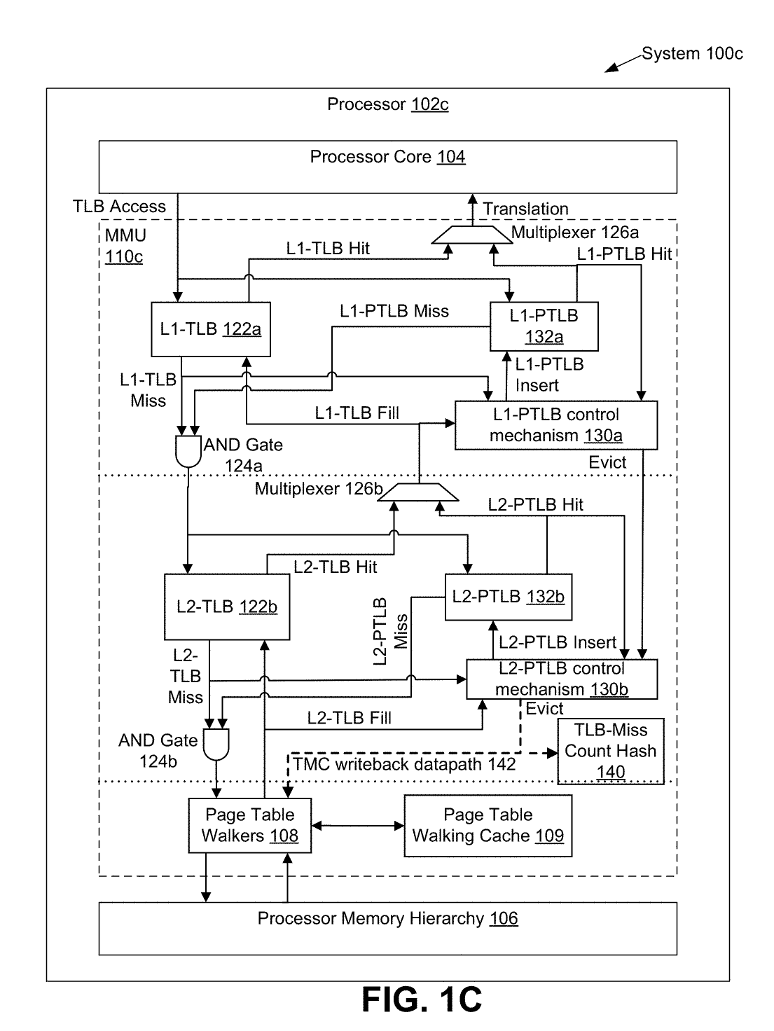

FIGS. 1A-C illustrate systems including one or more control mechanisms, one or more TLBs, and one or more PTLBs. In some embodiments, system 100a, system 100b, and system 100c are embodiments of the same system 100 and similarly numbered components have similar or the same functionalities. In some embodiments, processor 102a, processor 102b, and 102c are embodiments of the same processor 102 and similarity numbered components have similar or the same functionalities. In some embodiments, MMU 110a, MMU 110b, and MMU 110c are embodiments of the same MMU 110 and similarly numbered components have similar or the same functionalities.

FIG. 1A illustrates a system 100a including a TLB control mechanism 120, a TLB 122, a PTLB control mechanism 130, and a PTLB 132, according to one embodiment. The system 100a may include a processor 102a that includes a processor core 104, a processor memory hierarchy 106, the TLB control mechanism 120, the TLB 122, the PTLB control mechanism 130, and the PTLB 132. The processor 102a may further include a MMU 110a. In one embodiment, the MMU 110a may include the TLB control mechanism 120, TLB 122, PTLB control mechanism 130, and PTLB 132. In another embodiment, the TLB control mechanism 120, TLB 122, PTLB control mechanism 130, and PTLB 132 may be located in a different location (e.g., in the processor 102a outside of the MMU 110a, in the processor core 104, in the processor memory hierarchy 106, etc.). The TLB control mechanism 120, TLB 122, PTLB control mechanism 130, and PTLB 132 may be each implemented in hardware (e.g., TLB control mechanism 120 circuitry, TLB 122 circuitry, a PTLB control mechanism 130 circuitry, and a PTLB 132 circuitry, etc.). The processor memory hierarchy 106 may include one or more of a processor cache or main memory. In some embodiments, page tables reside in the main memory (e.g., processor memory hierarchy 106). In some embodiments, shadow page tables for TMCs reside in the main memory (e.g., processor memory hierarchy 106). In some embodiments, page tables and shadow page tables for TMCs reside in the main memory (e.g., processor memory hierarchy 106).

The processor core 104 may be coupled to the MMU 110a, the TLB control mechanism 120, the PTLB control mechanism 130, the processor memory hierarchy 106, the PTLB 132, and the TLB 122. The TLB control mechanism 120 may be coupled to the TLB 122. The PTLB control mechanism 130 may be coupled to the PTLB 132.

Translations and access permissions may be stored in an OS-managed memory structure called a page table. Page tables may be implemented as radix-tree of multiple levels. The leaf level includes PTEs. A PTE corresponds to a specific virtual page and contains its corresponding physical address and access permissions. The TLB 122 may include first PTEs 124 and the PTLB 132 may include second PTEs 134. In some embodiments, the TLB 122 has about 32-1536 PTEs 124. In some embodiments, the PTLB 132 has about 8-32 PTEs 134. To obtain a PTE, the MMU 110a searches the PTE in the TLBs (e.g., in L1-TLB, L1-PTLB, L2-TLB, L2-PTLB) or walks the page table starting from the root of the page table in processor memory hierarchy 106 (e.g., in processor cache and then main memory). The OS may load a pointer to the root of the page table in an internal register when the process is scheduled to run on the processor core 104. For instance, in x86 processors, the OS may load the address of the root of the page table in the CR3 register. The page table walking process utilizes the virtual address to index the different levels of the page table. The MMU 110a implements structures and techniques to obtain the virtual-to-physical mappings and page access permissions from the page table, cache the mappings, and enforce the page access permissions.

The TLB control mechanism 120 may be a first TLB control mechanism and the TLB 122 may be a first TLB. The TLB control mechanism 120 may store first translations into the TLB 122 based on a first policy (e.g., LRU). The PTLB control mechanism 130 may be a second TLB control mechanism and the PTLB 132 may be a second TLB. The PTLB control mechanism 130 may store second translations in the PTLB 132 based on a second policy (e.g., a TLB-miss heterogeneity-aware policy) that is different than the first policy.

The PTLB control mechanism 130 may use a policy that targets heterogeneity in TLB miss behavior and may reduce the overall TLB miss rate. The PTLB 132 may identify pages that are heavily accessed but have a large reuse distance (e.g., many other pages may be accessed between two accesses to this page, more pages may be accessed between two accesses to this page than the associativity of the policy of the TLB 122). The reuse of the translations of such pages may be poorly captured in TLB 122 by conventional replacement policies (e.g., LRU) and increasing the associativity of the TLB 122 may not improve the hit rates. The PTLB control mechanism 130 may dynamically identify heavily accessed pages that are not captured by the TLB (i.e. they miss in the TLB more than a threshold amount of times) and pin the PTEs in the PTLB 132 for these heavily accessed pages (may be referred to as pinnable pages) to increase the hits to these pages. The PTLB control mechanism 130 may track the number of TLB misses (TLB-miss count (TMC)) encountered for each PTE.

The TLB control mechanism 120 may receive a TLB access request (a memory access request, a data request) from the processor core 104. The TLB control mechanism 120 may determine whether the TLB 122 includes the translation corresponding to the TLB access request. In response to determining that the TLB 122 includes the translation (TLB hit), the TLB 122 may transmit the translation to the processor core 104. In response to determining that the TLB 122 does not include the translation (TLB miss), the TLB control mechanism 120 may transmit an indication to the PTLB control mechanism 130 of the TLB miss and the TLB access request. The TLB miss counter 136 may increment the TMC in response to the indication of the TLB miss.

The PTLB control mechanism 130 may determine whether the PTLB 132 includes the translation corresponding to the TLB access request. In response to the PTLB 132 including the translation (PTLB hit), the PTLB 132 may transmit the translation to the processor core 104. In response to the PTLB 132 not including the translation (PTLB miss), the PTLB control mechanism 130 may transmit the memory access to the processor memory hierarchy 106 (e.g., processor cache, main memory) and the processor memory hierarchy 106 may transmit the translation to the processor core 104.

The PTLB control mechanism 130 may store a respective TMC for each corresponding page. The corresponding TMC may indicate a number of TLB misses of the TLB 122 for the respective page. The PTLB control mechanism 130 may store a threshold count and a minimum TMC of the PTLB 132. In one embodiment, the PTLB control mechanism 130 may determine whether the TMC of the page (e.g., corresponding to the data request) is greater than a threshold count of the PTLB 132. The PTLB control mechanism 130 may store a translation of the page in the PTLB 132 in response to determining that the TMC is greater than the threshold count. In another embodiment, the PTLB control mechanism 130 may determine whether the TMC of the page (e.g., corresponding to the data request) is greater than a threshold count and a minimum TMC of the PTLB 132 (e.g., the lowest TMC among the entries of the PTLB 132). The PTLB control mechanism 130 may store a translation of the page in the PTLB 132 in response to determining the TMC is greater than the threshold count and the minimum TMC.

The processor 102a may include a TLB miss counter 136. In one embodiment, the TLB miss counter 136 is located in the PTLB control mechanism 130 (e.g., the PTLB control mechanism 130 may manage the TLB miss counts). The TLB miss counter 136 may be coupled to the TLB control mechanism 120. The TLB miss counter 136 may increment the TMC in response to a TLB miss in the TLB 122 for a corresponding page.

The PTLB control mechanism 130 may determine whether the PTLB 132 has at least one free entry. In response to determining that the PTLB 132 does not have at least one free entry (e.g., determining that a corresponding translation is in each of the entries of the PTLB 132), the PTLB control mechanism 130 may evict an entry corresponding to a minimum TMC from the PTLB 132 (e.g., the lowest TMC among the entries of the PTLB 132) prior to the PTLB control mechanism 130 storing the translation in the PTLB 132.

Responsive to storing a translation of a page in the PTLB 132, The PTLB control mechanism 130 may update the threshold count to be greater than the TMC corresponding to the newly stored translation (e.g., twice the TMC, etc.).

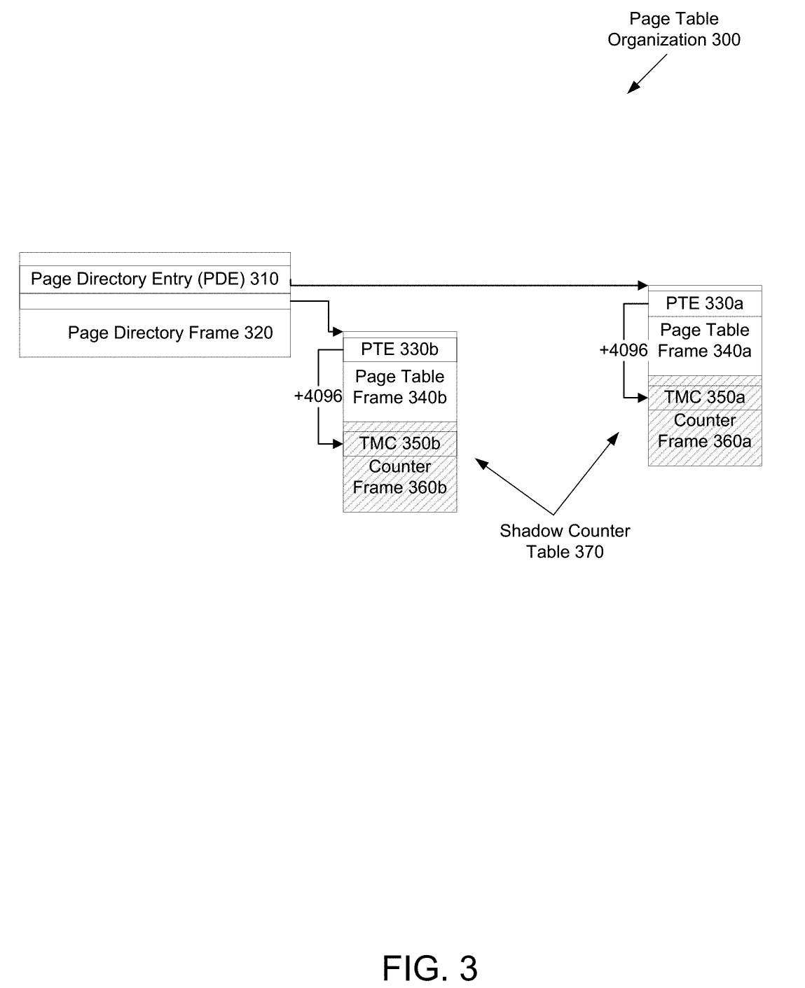

In one embodiment, the MMU 110a may include a hash table (e.g., TLB-miss count hash 140 of FIG. 1C). The TLB miss counter 136 associated with the TMC for the page may be stored in the hash table (e.g., the TMCs may be implemented in a hash table). In another embodiment, the TLB miss counter 136 associated with the TMC for the page may be stored in a shadow table corresponding to a page table (see FIG. 3) (the TMCs may be implemented in shadow table). In another embodiment, the translation of the page may be stored in a corresponding page table entry (PTE) of the page table (the TMCs may be implemented in page table PTEs).

FIG. 1B illustrates a system 100b including an L1-TLB control mechanism 120a, an L1-TLB 122a, L1-PTLB control mechanism 130a, an L1-PTLB 132a, an L2-TLB control mechanism 120b, an L2-TLB 122b, an L2-PTLB control mechanism 130b, and an L2-PTLB 132b, according to one embodiment. As used herein, TLB control mechanism 120 may refer to one or both of L1-TLB control mechanism 120a or L2-TLB control mechanism 120b. As used herein, TLB 122 may refer to one or both of L1-TLB 122a or L2-TLB 122b. As used herein, PTLB control mechanism 130 may refer to one or both of L1-PTLB control mechanism 130a or L2-PTLB control mechanism 130b. As used herein, PTLB 132 may refer to one or both of L1-PTLB 132a or L2-PTLB 132b.

Components in FIG. 1B (e.g., processor 102, processor core 104, and processor memory hierarchy 106, MMU 110, etc.) may have similar or the same functionalities as the components with the same reference numbers in FIG. 1A. L1-TLB control mechanism 120a, L1-TLB 122a, L1-PTLB control mechanism 130a, and L1-PTLB 132a may correspond to L1 memory cache of the processor 102b (e.g., correspond to a L1-level of the MMU. L2-TLB control mechanism 120b, L2-TLB 122b, L2-PTLB control mechanism 130b, and L2-PTLB 132b may correspond to L2 memory cache of the processor 102b (e.g., correspond to a L2-level of the MMU 110b).

The processor core 104 may be coupled to the MMU 110b, the L1-TLB control mechanism 120a, the L1-PTLB control mechanism 130a, the L1-TLB control mechanism 120b, the L2-PTLB control mechanism 130b, the processor memory hierarchy 106, the L2-PTLB 132b, the L2-TLB 122b, the L1-PTLB 132a, and the L1-TLB 122a. The L1-TLB control mechanism 120a may be coupled to the L1-TLB 122a. The L1-PTLB 130a may be coupled to the L1-PTLB 132a. The L2-TLB control mechanism 120b may be coupled to the L2-TLB 122b. The L2-PTLB 130b may be coupled to the L2-PTLB 132b.

L1-TLB control mechanism 120a and L2-TLB control mechanism 120b may store and evict translations from the L1-TLB 122a and the L2-TLB 122b based on a first policy (e.g., LRU). In one embodiment, L1-TLB control mechanism 120a and L2-TLB control mechanism 120b are the same control mechanism. In another embodiment, L1-TLB control mechanism 120a and L2-TLB control mechanism 120b are distinct control mechanisms.

L1-PTLB control mechanism 130a and L2-PTLB control mechanism 130b may store and evict translations from the L1-PTLB 132a and the L2-PTLB 132b based on a second policy that is different from the first policy. In one embodiment, L1-PTLB control mechanism 130a and L2-PTLB control mechanism 130b are the same control mechanism. In another embodiment, L1-PTLB control mechanism 130a and L2-PTLB control mechanism 130b are distinct control mechanisms.

The L1-TLB control mechanism 120a may receive a TLB access request (e.g., data request) from the processor core 104 and in response to a miss in the L1-TLB 122a, the L1-TLB control mechanism 120a may transmit the TLB access request to the L1-PTLB control mechanism 130a. In response to a miss in the L1-PTLB 132a, the L1-PTLB control mechanism 130a may transmit the TLB access request to the L2-TLB control mechanism 120b. In response to a miss in the L2-TLB 122b, the L2-TLB control mechanism 120b may transmit the TLB access request to the L2-PTLB control mechanism 130b. In response to a miss in the L2-PTLB 132b, the L2-PTLB control mechanism 130b may transmit the TLB access request to the processor memory hierarchy 106 and the processor memory hierarchy 106 may transmit the translation to the processor core 104. In response to a TLB hit of a TLB (e.g., L1-TLB 122a, L1-PTLB 132a, L2-TLB 122b, or L2-PTLB 132b), the TLB may transmit the translation to the processor core 104.

In some embodiments, the L1-TLB 122 has about 32 to 64 PTEs. In some embodiments, the L2-TLB has about 1536 entries. In some embodiments, the L1-PTLB 132a has about 4-16 entries. In some embodiments, the L2-PTLB 132b has about 16-64 entries. The L1-TLB 122a and L1-PTLB 132a may be smaller and faster than the respective L2-TLB 122b and L2-PTLB 132b. The PTLBs 132 may be smaller than the TLBs 122.

FIG. 1C illustrates a system 100c including an L1-TLB 122a, L1-PTLB control mechanism 130a, an L1-PTLB 132a, an L2-TLB 122b, an L2-PTLB control mechanism 130b, and an L2-PTLB 132b, according to one embodiment.

Components in FIG. 1C (e.g., processor 102, processor core 104, and processor memory hierarchy 106, MMU 110, L1-TLB 122a, L1-PTLB control mechanism 130a, L1-PTLB 132a, L2-TLB 122b, L2-PTLB control mechanism 130b, L2-PTLB 132b, etc.) may have similar or the same functionalities as the components with the same reference numbers in FIG. 1A and/or FIG. 1B. In one embodiment, the MMU 110c includes a page table walking cache (PTWC) 109 that caches one or more portions of the page table to enable faster page table walks. The MMU 110c may include a page table walker 108 that directly accesses the PTWC. The L1-TLB 122a may have 64 entries, may be 4-ways. The L2-TLB 122b may have 1536 entries, may be 12-ways. The PTWC 109 (e.g., a MMU 110 cache) may have four levels, may have 32-entries, may be 4-ways. The page table walker 108 may walk the 4-level page table. The TLB-miss count hash 140 (hash table) may have an entry size of 512-2 k.

The processor core 104 may be coupled to MMU 110c, L1-TLB 122a, L1-PTLB 132a, and multiplexer 126a. The L1-TLB 122a may be coupled to AND gate 124a, multiplexer 126a, multiplexer 126b, and L1-PTLB control mechanism 130a. Multiplexer 126a may be coupled to L1-TLB 122a, L1-PTLB 132a, L1-PTLB control mechanism 130a, and processor core 104. The L1-PTLB 132a may be coupled to L1-TLB 122a, multiplexer 126a, and L1-PTLB control mechanism 130a. The AND gate 124a may be coupled to the L1-TLB 122a, L1-PTLB 132a, and L2-TLB 122b. Multiplexer 126b may be coupled to L2-TLB 122b, L2-PTLB 132b, and L2-PTLB control mechanism 130b. The L2-PTLB 132b may be coupled to AND gate 124a, multiplexer 126b, L2-PTLB control mechanism 130b, and L1-PTLB control mechanism 130a. The L2-PTLB control mechanism 130b may be coupled to L2-TLB 122b, AND gate 124b, L2-PTLB 132b, page table walkers 108, multiplexer 126b, L1-PTLB control mechanism 130a, and TLB miss count hash 140. The page table walkers 108 may be coupled to AND gate 124b, L2-TLB 122b, TLB-miss count hash 140, L2-PTLB control mechanism, PTWC 109, and processor memory hierarchy 106. The PTWC 109 may be coupled with page table walkers 108. The processor memory hierarchy 106 is coupled with the page table walkers 108. The L1-PTLB control mechanism 130a may be coupled to multiplexer 126a, L1-PTLB 132a, L1-TLB 122a, AND gate 124a, multiplexer 126b, and L2-PTLB control mechanism 130b. L2-TLB 122b may be coupled to AND gate 124a, multiplexer 126b, L2-PLT 132b, AND gate 124b, page table walkers 108, and L2-PTLB control mechanism 130b. AND gate 124b may be coupled to L2-TLB 122b, L2-PTLB control mechanism 130b, L2-PTLB 132b, and page table walkers 108. TLB-miss count hash 140 may be coupled to L2-PTLB control mechanism 130b and page table walkers 108.

To meet the timing requirements of the load paths while minimizing the number of page table walks, TLBs may be organized as a hierarchy of multiple levels (e.g., similar to cache hierarchy). L1-TLB 122a may backed by L2-TLB 122b in a two-level hierarchy. L2-TLB 122b may be larger and slower than L1-TLB 122a. At each TLB level, an additional PTLB 132 is added to capture pinnable pages. PTLBs may be augmented within TLB systems without any changes on the other parts of the TLB hierarchy. PTLB control mechanism 130 may detect the pinnable pages and manages the insertion (e.g., storing) and eviction of PTLB entries.

Since TMCs are used to quantify the number of misses per PTE, a TMC is incremented each time there is a TLB miss for the page. Once a TLB miss occurs, the PTE for the page is filled from the next level in the hierarchy and the corresponding TMC is subsequently incremented. The TMCs may be used (e.g., are only used) at the PTE insertion time to guide the pinning. The TMCs may be stored (e.g., as entries in TLB miss count hash structures) for pages with high TLB misses, so that all TMCs of all TLB entries are not stored (e.g., TMCs for pages with low TLB misses are not stored).

Referring to FIG. 1C, the L1-TLB 122a and L1-PTLB 132a may receive a TLB access request from the processor core 104. In response to the corresponding translation being located in the L1-TLB 122a, an indication of an L1-TLB hit is transmitted to multiplexer 126a. In response to the corresponding translation being located in the L1-PTLB 132a, an indication of an L1-PTLB hit is transmitted to the L1-PTLB control mechanism 130a and multiplexer 126a. In response to receiving one or more of L1-TLB hit or L1-PTLB hit, multiplexer 126a transmits the translation to the processor core 104.

In response to the translation not being located in the L1-TLB 122a, an indication of an L1-TLB miss is transmitted to the AND gate 124a and L1-PTLB control mechanism 130a. In response to the translation not being located in the L1-PTLB 132a, an indication of an L1-PTLB miss is transmitted to the AND gate 124a. In response to receiving an indication of an L1-TLB miss and an indication of an L1-PTLB miss, the AND gate 124a transmits the TLB access request to the L2-TLB 122b and the L2-PTLB 132b.

In response to the translation being located in the L2-TLB 122b, an indication of an L2-TLB hit is transmitted to the multiplexer 126b. In response to the translation being located in the L2-PTLB 132b, an indication of an L2-PTLB hit is transmitted to the multiplexer 126b and the L2-PTLB control mechanism 130b. In response to receiving one or more of L2-TLB hit or L2-PTLB hit, multiplexer 126b transmits a L1-TLB fill (insert) to the L1-TLB 122a and the L1-PTLB control mechanism 130a. In response to the L1-TLB fill, the corresponding translation may be stored in the L1-TLB 122a. In response to the L1-PTLB control mechanism 130a determining the L1-TLB fill meets the second policy (e.g., TMC aware policy), the L1-PTLB control mechanism 130a may transmit an indication of an L1-PTLB insert to the L1-PTLB 132 to store the corresponding translation in the L1-PTLB 132a. In response to receiving the L1-TLB fill, the L1-TLB 122a and/or the L1-PTLB 132a may cause the multiplexer 126a to transmit the translation to the processor core 104 (e.g., transmit an L1-TLB hit and/or L1-PTLB hit to the multiplexer 126a which transmits the translation to the processor core 104).

In response to the corresponding translation not being located in the L2-TLB 122b, an indication of an L2-TLB miss is transmitted to AND gate 124b and L2-PTLB control mechanism 130b. In response to the corresponding translation not being located in the L2-PTLB 132b, an indication of an L2-PTLB miss may be transmitted to the AND gate 124b. In response to receiving indications of L2-TLB miss and L2-PTLB miss, the AND gate 124b transmits the TLB access request to the page table walkers 108. The page table walkers 108 are coupled to the PTWC 109 and determine whether the PTWC 109 has the corresponding translation. In response to the PTWC 109 having the translation, the page table walkers 108 obtain the translation from the PTWC 109. In response to the PTWC 109 not having the translation, the page table walkers 108 transmit the data request corresponding to the TLB access request to the processor memory hierarchy 106 and receive the translation from the processor memory hierarchy 106. In one embodiment, the translation is stored in the processor memory hierarchy 106. In another embodiment, the translation is obtained from another memory device (e.g., external to the processor 102). In response to receiving the translation, the page table walkers 108 transmit an L2-TLB fill to the L2-TLB 122b and the L2-PTLB control mechanism 130b. In response to the L2-TLB fill the corresponding translation may be stored in the L2-TLB 122b. In response to the L2-PTLB control mechanism 130b determining the L2-TLB fill meets the second policy (e.g., TMC aware policy), the L2-PTLB control mechanism 130b may transmit an indication of an L2-PTLB insert to the L2-PTLB 132b to store the corresponding translation in the L2-PTLB 132b. In response to receiving the L2-TLB fill, the L2-TLB 122b and/or the L2-PTLB 132b may transmit the translation to the multiplexer 126b which transmits a L1-TLB fill to the L1-TLB 122a and L1-PTLB control mechanism 130a.

In response to a PTLB control mechanism 130 determining that a new pinnable page is to be inserted into a corresponding PTLB 132 (e.g., L1-PTLB insert, L2-PTLB insert), the PTLB control mechanism 130 may evict an entry from the corresponding PTLB 132. The evicted entry may correspond to the minimum TMC in the PTLB.

Hits in the PTLB 132 that are misses in the TLB 122 may be treated as misses and the corresponding counter may be incremented. This avoids priority inversion where a less accessed page can become more pinnable because it was not captured by the PTLB 132.

The presence of PTLB 132 does not impact the normal insertion and eviction process of the TLB 122. This allows better TMC profile fidelity by only incrementing TMC on a true TLB miss. This may cause duplicate entries in PTLB 132 and TLB 122. However, given the small size of PTLBs 132, the duplicate number of entries is marginal. In one embodiment, this duplication is avoided by not filling a pinned PTE into the TLB 122. In another embodiment, the duplication is allowed so as not to change the behavior of the TLB misses.

In some implementations, one or more TLB miss counters 136 (one or more TMCs) may be cached in the PTLB control mechanism 130. Caching one or more TLB miss counters 136 (TMCs) in the PTLB control mechanism 130 may help avoid communication between levels (e.g., L1, L2, etc.). In some implementations, the PTLB control mechanism 130 caches one or more TMCs (TLB miss counters 136) corresponding to the PTEs that are pinned in the PTLB 132 and one or more additional TMCs (one or more additional TLB miss counters 136) that do not correspond to the PTEs that are pinned in the PTLB 132. In response to caching the one or more TMCs corresponding to the PTLB 132 and one or more additional TMCs not corresponding to the PTLB, TMC updates (updates to the TLB miss counters 136) do not need to be immediate. The PTLB control mechanism 130 may absorb the TMC updates which may relieve demand on the memory bandwidth to update the TMCs in the shadow page table or the page table PTEs. When the cached TMCs are to be written back to the shadow page table or the page table PTEs, the writeback datapath (e.g., TMC writeback datapath 142 of FIG. 1C) may be used. If TMCs are kept in the TMC hash in the MMU 110, bandwidth may not be a concern.

When an entry is in the PTLB 132, TMC updates may be performed in the cached TMC in the PTLB control mechanism 130 to avoid additional communication between the levels. TMC values (e.g., the latest TMC values) may be written back to the counter storage at the time PTLB entries are evicted. This optimization avoids additional traffic between different levels.

Since some TMCs may be cached by the PTLB control mechanism, TMCs can become inconsistent when the same PTE is cached in multiple levels or in multiple places. A compare-and-update operation may be used to update the counter storage with the highest counter value. For example, if L1-PTLB 132a has a counter value of 2000 for a first page, L2-PTLB 132b has a counter value of 20 for the first page, and the counter storage (e.g. in TLB miss count hash or shadow table in main memory) has a counter value of 10 for the first page and if the corresponding entry from L1-PTLB 132a is evicted before the corresponding entry from L2-PTLB 132b, the counter storage will be updated with 2000. Later, when the corresponding entry is evicted from L2-PTLB 132b, the update is rejected since 20 is less than 2000. This preserves the pinnability of the pages in an inconsistent environment.

TLBs may be used to cache translations (e.g., PTEs) and the TLBs may be analogous to caches. The MMU 110c may implement different levels of TLBs. In contrast to TLBs, PTWC 109 may cache upper levels of the page table and may reduce the number of memory accesses to obtain the PTE. For example, a TLB miss can result in up to four memory accesses to walk the page table and if the PTWC 109 caches the relevant PUD (page upper directory) or PMD (page middle directory), fewer memory access are performed to complete the walk process. A page table walker 108 may check the PTWC 109 and proceed with the memory access to obtain the translation.

In one embodiment, heterogeneity of TLB misses is known a-priori and may not change substantially over time. The OS (e.g., via software) may set a special pinning bit (e.g., pinning hints) in the PTE during the first minor page fault for each of the pinnable pages. Such a bit may be checked by the PTLB control mechanism 130 and may override the dynamic pinning heuristic in the case pinning is indicated. A compiler-optimization or profiling may be used to guide or insert the pinning hints.

Page table updates, resulting from change in the corresponding physical pages or change in page permission, may include updating PTE entries in the page table and invalidating all current copies in the system. PTLB 132 may be affected by page table updates in the relevance of the current TMC to the new mapping and in correctly invalidating all copies in the caching structures introduced by PTLB 132. The relevance of the current TMC of the PTE is affected when the updated PTE no longer demonstrates the previous behavior. This happens when the run-time allocation library (e.g., libc) recycles previously freed allocations that later became unmapped. When the OS updates the PTE entry, it may also reset the corresponding TMC. Otherwise, the PTLB 132 may take more time to adapt to the new behavior, especially in the case of a previous high-pinnable profile. To avoid correctness issues, page table updates may invalidate the corresponding PTLB entries. Each processor core 104 may execute an explicit invalidation instruction that involves interrupting participating processor cores 104 in the system 100. Similar to TLB 122 structures, PTLB 132 should also invalidate the corresponding PTE entry when receiving TLB invalidation instructions.

When a virtual machine (VM) is used, overheads of virtual memory increase. The guest virtual addresses are to be translated to host virtual addresses and the host virtual addresses then are to be translated into host physical addresses. Eventually, the TLB entries will have a virtual address of the VM and the corresponding host physical address along with the permissions. The hash-style scheme of PTLB 132 may be a microarchitecture feature. Other schemes may include explicit management (e.g., load and store) of TMC counters. In one embodiment, the TMC allocation task is offloaded on the hypervisor (e.g., shadowing the hypervisor page table). The TMC counters may be loaded when the translation is loaded from the hypervisor page table. Software hints for pinning may be hinted from the guest OS to the hypervisor at the time of minor page fault (e.g., physical page allocation).

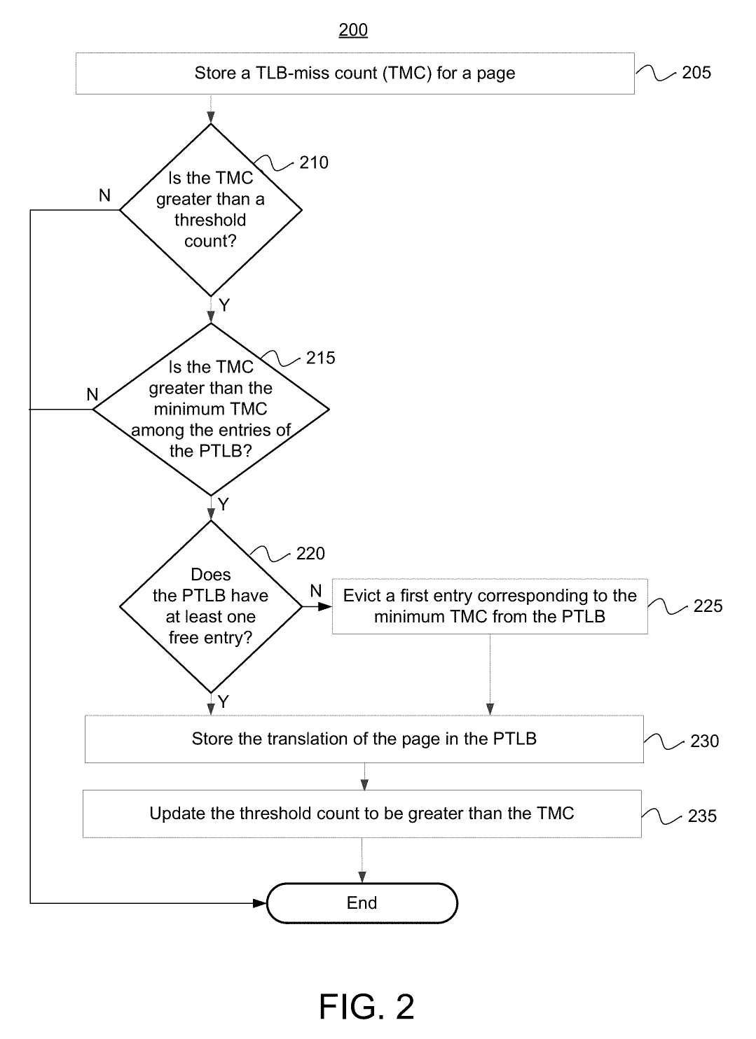

FIG. 2 is a flow diagram of a method 200 of storing a translation of a page in a PTLB 132, according to one embodiment. Method 200 may be performed by processing logic that may include hardware (e.g., circuitry, dedicated logic, programmable logic, microcode, etc.), software (such as instructions run on a processor, a general purpose computer system, or a dedicated machine), firmware, microcode, or a combination thereof. In one embodiment, method 200 may be performed, in part, by processor 102 of one or more of FIGS. 1A-1C. In another embodiment, method 200 may be performed on one or more of MMU 110, PTLB control mechanism 130, and so forth.

For simplicity of explanation, the method 200 is depicted and described as a series of acts. However, acts in accordance with this disclosure can occur in various orders and/or concurrently and with other acts not presented and described herein. Furthermore, not all illustrated acts may be performed to implement the method 200 in accordance with the disclosed subject matter. In addition, those skilled in the art will understand and appreciate that the method 200 could alternatively be represented as a series of interrelated states via a state diagram or events.

Referring to FIG. 2, at block 205, the processing logic stores a TLB-miss count (TMC) for a page. During a TLB fill from the next level, the TMC for the page may be sent to the processing logic (e.g., PTLB control mechanism 130).

At block 210, the processing logic determines whether the TMC is greater than a threshold count. The threshold count may be maintained by the processing logic (e.g., PTLB control mechanism 130) and may be adapted to the TMC of the few most pinnable pages over the course of an application (see block 235). The threshold value may be initially set to zero and only updated each time there is an insertion into the PTLB 132. In response to determining that the TMC is not greater than the threshold count, method 200 ends. In response to determining that the TMC is greater than the threshold count, method 200 continues to block 215.

At block 215, the processing logic determines whether the TMC is greater than a minimum TMC (e.g., the lowest TMC among the entries of the PTLB 132) of the PTLB 132. One or both of block 210 and 215 may be used by the processing logic to detect whether the page is a pinnable page (e.g., to indicate whether it is more profitable to pin the translation in the PTLB 132 than an existing entry in the PTLB 132). In response to determining that the TMC is not greater than the minimum TMC, method 200 ends. In response to determining that the TMC is greater than the minimum TMC, method 200 continues to block 220.

At block 220, the processing logic determines whether the PTLB 132 has at least one free entry. In response to determining that the PTLB 132 does not have at least one free entry, method 200 continues to block 225. In response to determining that the PTLB 132 does have at least one free entry, method continues to block 230.

At block 225, the processing logic evicts a first entry corresponding to the minimum TMC (e.g., the PTLB entry with the lowest TMC) from the PTLB 132. The TMC of the evicted entry is written back to the profile storage (e.g., counter storage) using a compare-and-update operation. Once an entry is freed by eviction, flow may continue to block 230.

At block 230, the processing logic stores the translation of the page in the PTLB 132 (e.g., the new pinnable PTE is stored in the entry freed by eviction). The current TMC corresponding to the translation may be copied to the counter field of the entry.

At block 235, the processing logic updates the threshold count to be greater than the TMC. For example, the threshold may be updated with twice the value of the TMC of the entry. Updating to twice the TMC of the entry may provide hysteresis to the entry just stored and may prevent constant flip-flop of entries in the PTLB 132. If a translation is stored as a new PTLB entry in the PTLB 132, doubling the threshold gives new PTLB entries a better chance to be reused rather than be evicted and replaced by a new PTE entry corresponding to the very next TLB miss. As the TMCs increase, so does the threshold and with every new insertion, it becomes increasingly more difficult for a new TLB miss to evict existing entries from the PTLB 132. At high threshold values, the PTLB 132 already captures extremely pinnable pages, thus using twice the TMC as the threshold count avoids the case where slightly more pinnable pages replace existing pages without a large performance gain. If a new page becomes immensely pinnable, it will eventually cross the threshold and trigger an insertion. In some embodiments, the threshold is updated with twice the value of the TMC of the entry. In some embodiments, the threshold is updated based on a multiplier of more than two (e.g., with more than twice the value of the TMC of the entry). In some embodiments, the threshold is updated based on a multiplier of less than two (e.g., with one to two times the value of the TMC of the entry. The multiplier (for updating the threshold in view of the TMC of the entry) may be tuned for different implementations based on experiments and heuristics.

FIG. 3 illustrates a page table organization 300 with a shadow counter table 370 (e.g., the shaded portion), according to one embodiment. A page directory entry (PDE) 310 may include one or more page directory frames 320. The PDE 310 may correspond to one or more PTEs 330. Each PTE may include a page table frame 340.

Counters (e.g., TLB miss counters, TMC 350) may be stored and accessed to obtain a useful TMC profile without adding substantial performance and power overhead. The higher the number of pages accessed by an application, the higher the overheads. TMCs may be stored and managed in different ways that vary where the counters are stored and how the counters interact with system software.

In one embodiment, the counters are stored in a dedicated shadow counter table 370 that shadows the page table. The page table may include page table entries 330 and page table frames 340. The shadow counter table 370 may include TMCs 350 and counter frames 360. Providing the shadow counter table 370 may be an architectural change and the OS may be responsible for creating the page table and the shadow counter table 370. The application software may be unaware of this change and the counters may be managed by the PTLB control mechanism 130. The counters may be global and the processor core 104 may update the counters independently. The physical frame (e.g., counter frame 360) for the shadow counter table 370 may follow (e.g., immediately follow) the frame (e.g., page table frame 340) for the corresponding page table. This allows a single page walk to obtain both the PTE 330 and the TMC 350 for a page. This organization also maintains cache locality of the PTEs 330 and avoids performance degradation of streaming accesses. During a TLB miss (fill), the corresponding counters may be incremented using a remote increment operation, performed by a memory controller and the TMC lines may not be cached. The remote increment operation is a low priority operation and the memory controller can choose to drop the request if there is high contention in the memory controller. Occasionally dropping the requests does not reduce the effectiveness of the TMC profile. In case of eviction of an entry from the PTLB 132, the corresponding TMC 350 is written back using a remote compare-and-update operation. Writebacks may use the TMC writeback datapath 142 (see FIG. 1C).

In another embodiment, counters (e.g., TLB miss counters, TMC 350) are stored in a hash table (e.g., TLB-miss count hash 140 of FIG. 1C) within the MMU 110. To keep the counter size small, the counters may be periodically aged by flash clearing some of the higher order bits of all counters in the hash table. The number of entries in the hash table cannot be too large to keep the power and area overheads low. This may inevitably cause aliasing between TMCs 350 of different pages. In some embodiments, a multiple pinnable pages alias is present which may not have an impact since all pages may be correctly marked pinnable. If one translation is more useful than the other translations in the PTLB 132, the per-entry TMC 350 in the PTLB 132 may eventually end up evicting the less useful translations. In some embodiments, multiple non-pinnable pages alias is present which may not have an impact since all pages will be correctly marked as un-pinnable. In some embodiments, pinnable and non-pinnable pages alias is present which may cause some performance degradation since non-pinnable pages can be incorrectly pinned in the PTLB 132. The per-entry TMC 350 in the PTLB 132 may eventually evict the entries that are not frequently used, where the adaptive threshold keeps them out for most of the execution time.

Upon an eviction from the PTLB 132, the TMC 350 of the evicted translation is written back to the hash table using a compare-and-update operation. This may use a TMC writeback datapath 142 to the TLB-miss count hash 140 (see FIG. 1C).

In yet another embodiment, counters (e.g., TLB miss counters, TMC 350) are stored in the remaining unused bits in every PTE 330 instead of using a shadow counter table 370. This avoids additional storage overheads and reduces the extra memory requests needed for counter management. The TMC 350 is available along with the PTE 330 during a fill. The number of bits available to store the TMC 350 becomes the concern and can potentially affect the quality of the TMC profile. This can be mitigated by counter compression and periodic aging to not require as many bits. Another option is to use mantissa-exponent style encoding to achieve a counter range.

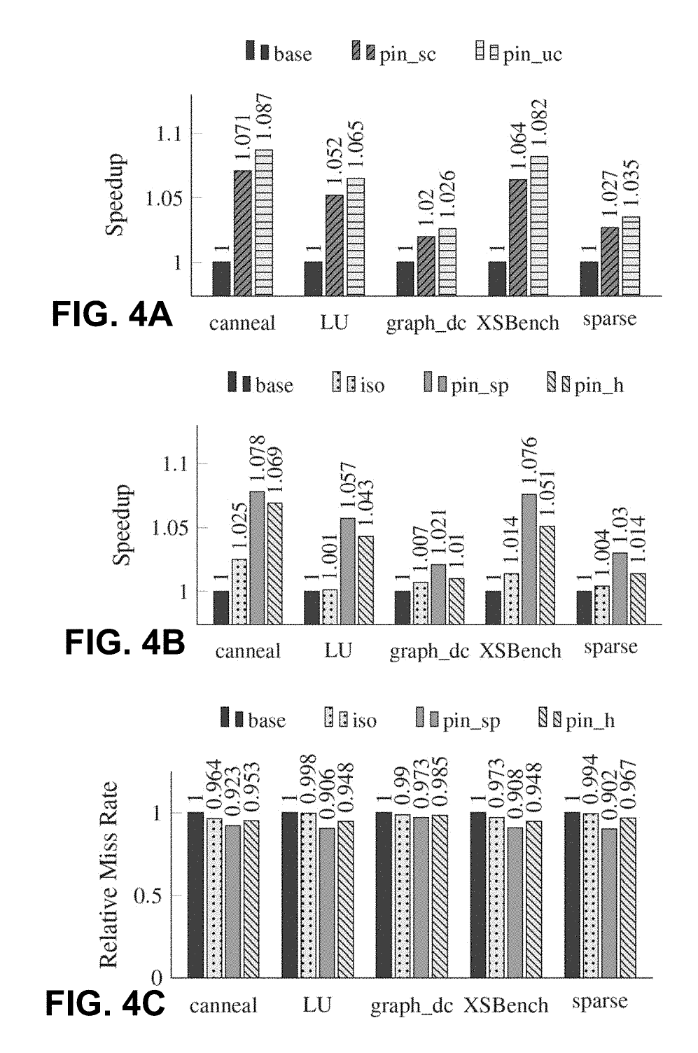

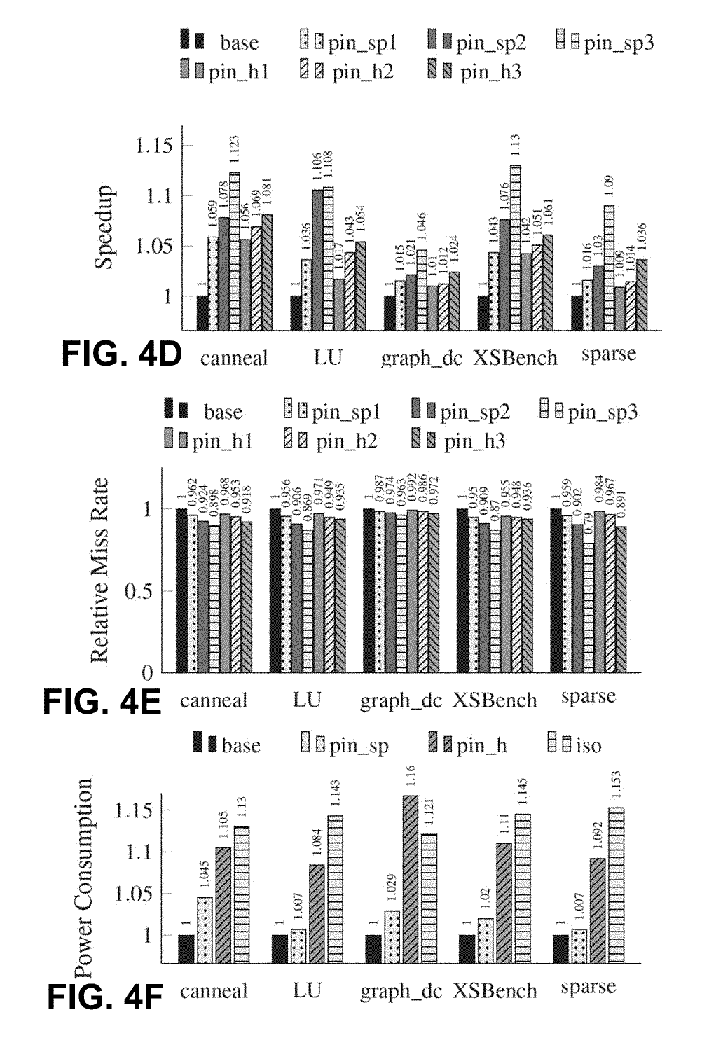

FIGS. 4A-F are bar graphs illustrating performance improvement for a set of workloads, according to embodiments. The base model may have a baseline system configuration as shown in Table 1.

TABLE 1
The baseline system configuration

| Component | Configuration |
|---|---|
| Processor | 8 cores |
| Core | 2 GHz, 2 memory operations issue/cycle, 16 max. |
| | outstanding memory requests |
| L1D | 32 KB, 8-way, 64 B block, 4 cycles |
| L2 | 256 KB, 8-way, 64 B block, 10 cycles |
| L3 | 8 MB, 8-way, 64 B block, 20 cycles |
| Coherency | MESI Protocol |
| L1-TLB | 64 entries, 4-way, 4 cycles |
| L2-TLB | 1536 entries, 12-way, 10 cycles |
| PTWC | 32-entry, 4-way, 10-cycle access latency |
| DRAM | 32 GB 2133 MHz |

The workloads (e.g., benchmarks) may be as shown in Table 2.

| | | TLB |
|---|---|---|
| | | misses/thousands |
| Workload | Description | mem. Reference |
| Canneal | Kernel from Parsec 3.0 | 13 |
| LU | LU decomposition | 500 |
| GraphBIG degree centrality | Social Media Monitoring | 32 |
| | workload | |
| XSBench | Monte Carlo neutronics | 15 |
| | application | |
| Sparse Multiplication | Sparse matrix-matrix | 13 |
| | multiplication | |

The bar graphs compare performance of system 100 with a base model (no pinning and no added entries) and an iso model (base system with added entries). System 100 includes a PTLB 132. The base model includes a TLB 122 but does not include a PTLB 132. The iso model is the same as the base model with 2-way associativity added to each set (e.g., 32 entries added to L1-TLB and 256 entries added to L2-TLB). The iso model merely increases the TLB size by a number of entries equal to or greater than the number of entries that the PTLB 132 uses for pinning. The number of pre-translation TLB-misses in a counter (TMC) is maintained for the system 100, base model, and iso model. The PTLB designs may save and update TMCs by saving them in a shadow page table (e.g., shadow counter table 370) in memory or in a hash table (e.g., TLB-miss count hash 140 of FIG. 1C) that resides in the MMU 110. Both designs are compared to the base system and the iso model. For both designs, an 8-entry fully associative L1-PTLB 132a and a 32-entry fully-associative L2-PTLB 132b are used. The two designs are referred to as shadow-page pinning (pin_sp) (e.g., using a (e.g., shadow counter table 370) and hash table pinning (pin_h) (e.g., using a TLB-miss count hash 140).

FIG. 4A is a bar graph illustrating execution time speedup of the unified TMC (pin_uc) and separate TMC (pin_sc) models normalized to base, according to one embodiment. The unified TMC (pin_uc) refers to one unified TMC per page translation for both L1-PTLB 132a and L2 PTLB 132b. Separate TMC (pin_sc) refers to a first TMC per page translation for L1-PTLB 132a and a second TMC per page translation for L2-PTLB 132b (e.g., one for each level). The unified-TMC model performs better than the separate-TMC model for each of the benchmarks. The maximum speedup unified-TMC achieves 8.7% maximum speedup relative to base whereas the separate-TMC model achieves 7.1% maximum speedup relative to base. The systems 100a-c (FIGS. 1A-C) may use a unified-TMC model.

The disparity in performance of the two models may stem from the access and miss pattern between L1-TLB 122a and L2-TLB 122b since both designs depend on the number of TLB-misses in deciding whether a translation should be pinned in the PTLB 132 or not. When TLB misses are few, the miss-heterogeneity among page translations may not be clear and the pinning-worthy translations may not be identified. The higher the TLB accesses and consequently the TLB misses, the more accurate the pinning decision may be. Since the L2-TLB 122b usually has much less accesses and misses than the L1-TLB, it may take the L2-PTLB 132b more time to converge and detect the highest-missing translations. Including the misses-history of L1-TLB 122a in the pinning decision of L2-PTLB 132b may help the L2-PTLB 132b to converge to a more accurate decision of which translations to pin much faster. Thus, the unified-TMC model may have a higher execution-time speedup than the separate-TMC model.

FIG. 4B is a bar graph illustrating execution time speedup normalized to base for different benchmarks, according to one embodiment. FIG. 4C is a bar graph illustrating relative miss rate normalized to base for different benchmarks, according to one embodiment. The PTLB 132 may reduce the number of TLB misses and page table walks and thereby improve the performance of applications. FIG. 4B illustrates the impact of the shadow-page pinning (pin_sp) PTLB 132 design and hash-table pinning (pin_h) PTLB 132 design on the performance speedup for five benchmarks. FIG. 4C illustrates the impact of the shadow-page pinning (pin_sp) PTLB 132 design and hash-table pinning (pin_h) PTLB 132 design on the TLB miss ratio. The shadow-page pinning design and hash-table pinning design are compared with a base system (no pinning or extra associativity) and an iso model (extra entries used as an additional associativity). The shadow-page pinning design achieves the highest speedup and the lowest relative miss rate for all benchmarks and is followed by the hash-table pinning design. Increasing the TLB size, as in the case of the iso model, does not capture the high-miss, low-locality page translations.

The shadow-page pinning design may provide more accurate TMCs by avoiding having collisions that may occur with a hashing function. The hash-table pinning design may not incur the extra traffic for fetching and updating the TMC since it uses a hash table that resides in the MMU 110.

FIG. 4D is a bar graph illustrating execution time speedup normalized to base for different sizes and different benchmarks, according to one embodiment. FIG. 4E is a bar graph illustrating relative miss rate normalized to base for different sizes and different benchmarks, according to one embodiment. FIGS. 4D-E compare three different variations for shadow-page pinning (pin_sp): 1) 4-entry L1-PTLB and 16-entry L2-PTLB, both fully associative (pin_sp1); 2) 8-entry L1-PTLB and 32-entry L2-PTLB, which is the default configuration used in FIGS. 4B-C; and 3) 16-entry L1-PTLB and 64-entry L2-PTLB, both fully-associative (pin_sp3). FIGS. 4D-E further compare three different variations of hash-table pinning (pin_h): 1) 512-entry hash-table size (pin_h1); 2) 1k-entry hash-table size (pin_h2), which is the default configuration used in FIGS. 4B-C; and 3) 2k-entry hash-table size (pin_h3). FIGS. 4D-E show a similar trend as shown in FIGS. 4B-C, where shadow-page pinning achieves the higher execution time speedup and relative miss rate reduction compared to the base. The smaller configurations from both designs achieve less improvement when compared to the larger counterparts. As the size of the structures increases, either the PTLB 132 or the hash-table, there are higher improvements. For example, in Canneal, going from pin_sp1 to pin_sp2 results in an extra 1.9% speedup and going from pin_sp2 to pin_sp3 results in an extra 4.5% speedup.

FIG. 4F is a bar graph illustrating power consumption normalized to base for different benchmarks, according to one embodiment. The shadow-page pinning (pin_sp) and hash-table pinning (pin_h) are compared to both iso model and base. Relatively small power increase over base is incurred compared to the power increase iso incurs. The average power increase for the hash-table pinning design is 11.9% and for shadow-page pinning design is 2.17%, whereas for iso model is 13.86%.

The area increase for the different configurations may be as shown in Table 3.

TABLE 3
Area increase normalized to base

| | | % increase | % increase |
|---|---|---|---|
| | | compared to base | compared to whole |
| Configuration | Area (mm²) | MMU | base core |
| base | 0.119 | N/A | N/A |
| iso | 0.122 | 2.00 | 0.01 |
| pin_sp | 0.121 | 1.00 | 0.01 |
| pin_h | 1.38 | 15.92 | 0.10 |

MMU area increase for the shadow-page pinning design is 1%, for the iso model is 2%, and for the hash-table pinning is 15.92% compared to base MMU area. With a core area of 20 mm², the iso model and shadow-page pinning design incur 0.01% area increase compared to the area of the base model core and the hash-table pinning design incurs 0.10% increase in the whole core area compared to base.

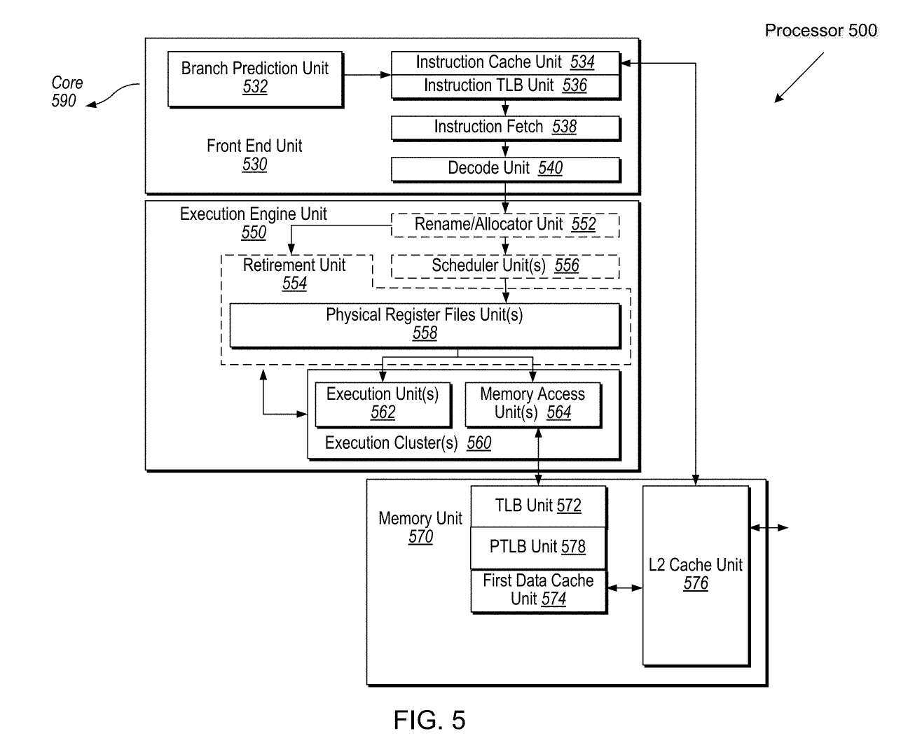

FIG. 5 is a block diagram illustrating a micro-architecture for a processor that implements the PTLB control mechanism 130 and PTLB 132, according to one embodiment. Specifically, processor 500 depicts an in-order architecture core and a register renaming logic, out-of-order issue/execution logic to be included in a processor according to at least one embodiment of the disclosure. The embodiments of the PTLB control mechanism 130 and PTLB 132 can be implemented in processor 500. In one embodiment, processor 500 is the processor 102 of one or more of FIGS. 1A-C.

Processor 500 includes a front end unit 530 coupled to an execution engine unit 550, and both are coupled to a memory unit 570. The processor 500 may include a core 590 that is a reduced instruction set computing (RISC) core, a complex instruction set computing (CISC) core, a very long instruction word (VLIW) core, or a hybrid or alternative core type. As yet another option, processor 500 may include a special-purpose core, such as, for example, a network or communication core, compression engine, graphics core, or the like. In another embodiment, the core 590 may have five stages.

The front end unit 530 includes a branch prediction unit 532 coupled to an instruction cache unit 534, which is coupled to an instruction translation lookaside buffer (TLB) unit 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decode unit 540 may be implemented using various different mechanisms. Examples of suitable mechanisms include, but are not limited to, look-up tables, hardware embodiments, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include TLB unit 572 coupled to PTLB unit 578 coupled to a data cache unit (DCU) 574 coupled to a level 2 (L2) cache unit 576. The TLB unit 572 may include the TLB control mechanism 120 and the TLB 122 of one or more of FIGS. 1A-C. The PTLB unit 578 may include the PTLB control mechanism 130 and the PTLB 132 of FIGS. 1A-C. In some embodiments DCU 574 may also be known as a first level data cache (L1 cache). The DCU 574 may handle multiple outstanding cache misses and continue to service incoming stores and loads. It also supports maintaining cache coherency. The TLB unit 572 and PTLB unit 578 may be used to improve virtual address translation speed by mapping virtual and physical address spaces. In one exemplary embodiment, the memory access units 564 may include a load unit, a store address unit, and a store data unit, each of which is coupled to the TLB unit 572 in the memory unit 570. The L2 cache unit 576 may be coupled to one or more other levels of cache and eventually to a main memory.

The processor 500 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.

It should be understood that the core may not support multithreading (e.g., executing two or more parallel sets of operations or threads, time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology)).

While register renaming is described in the context of out-of-order execution, it should be understood that register renaming may be used in an in-order architecture. While the illustrated embodiment of the processor also includes separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

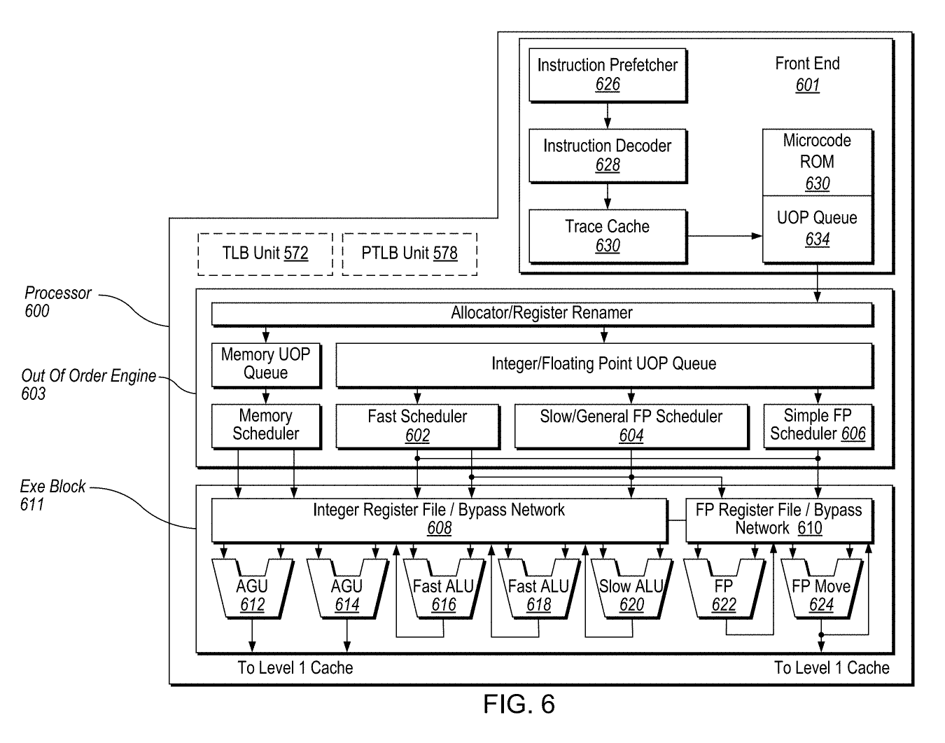

FIG. 6 illustrates a block diagram of the micro-architecture for a processor 600 includes the PTLB control mechanism 130 and PTLB 132, according to one embodiment. In one embodiment, processor 600 is the processor 102 of one or more of FIGS. 1A-C.

In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 601 is the part of the processor 600 that fetches instructions to be executed and prepares them to be used later in the processor pipeline. The embodiments of the TLB unit 572 and the PTLB unit 578 may be implemented in processor 600.

The front end 601 may include several units. In one embodiment, the instruction prefetcher 626 fetches instructions from memory and feeds them to an instruction decoder 628 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 628 accesses the microcode ROM 632 to do the instruction. For one embodiment, an instruction can be decoded into a small number of micro ops for processing at the instruction decoder 628. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and reorder the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 610 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is included of a number of execution units: address generation unit (AGU) 612, AGU 614, fast ALU 616, fast ALU 618, slow ALU 620, floating point ALU 622, floating point move unit 624. For one embodiment, the floating point execution blocks 622, 624, execute floating point, MMX, SIMD, and SSE, or other operations. The floating point ALU 622 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 620 as the slow ALU 620 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 622, 624, can be implemented to support a range of operands having bits of various widths. For one embodiment, the floating point units 622, 624, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions herein, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX™ registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

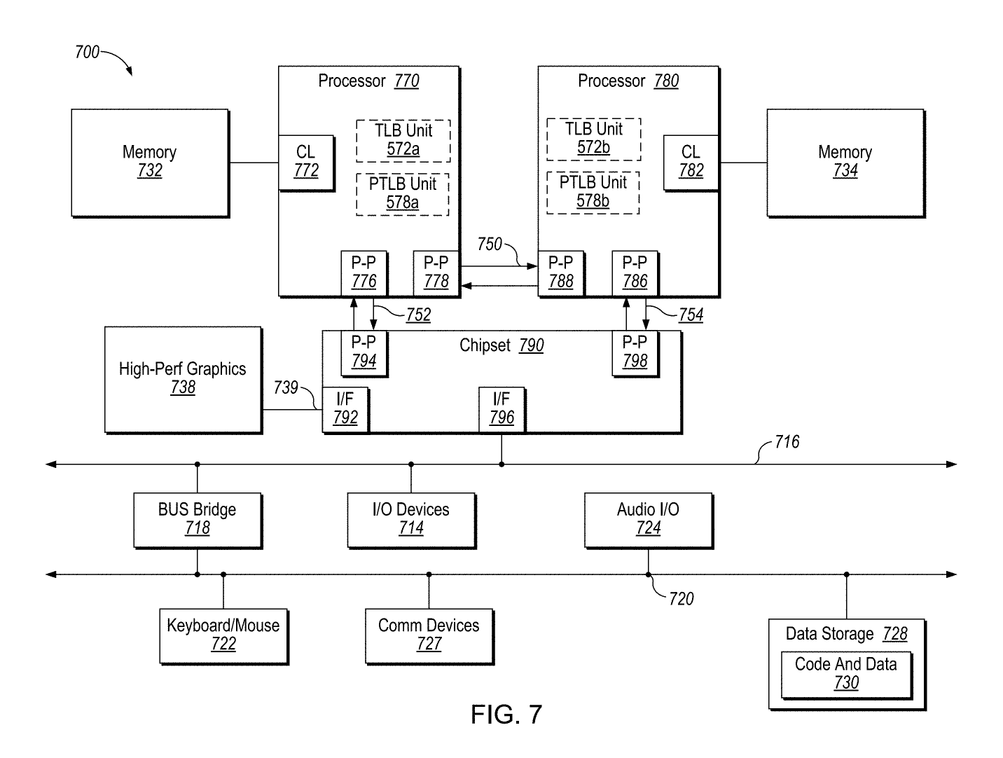

Embodiments may be implemented in many different system types. Referring now to FIG. 7, shown is a block diagram of a multiprocessor system 700 in accordance with an embodiment. As shown in FIG. 7, multiprocessor system 700 is a point-to-point interconnect system, and includes a first processor 770 and a second processor 780 coupled via a point-to-point interconnect 750. As shown in FIG. 7, each of processors 770 and 780 may be multicore processors, including first and second processor cores (i.e., processor cores 774a and 774b and processor cores 784a and 784b), although potentially many more cores may be present in the processors. The processors each may include hybrid write mode logics in accordance with an embodiment of the present. The embodiments of the TLB unit 572 and PTLB unit 578 can be implemented in the processor 770, processor 780, or both.

While shown with two processors 770, 780, it is to be understood that the scope of the present disclosure is not so limited. In other embodiments, one or more additional processors may be present in a given processor.

Processors 770 and 780 are shown including integrated 110 control logic (“CL”) 772 and 782, respectively. Processor 770 also includes as part of its bus controller units point-to-point (P-P) interfaces 776 and 788; similarly, second processor 780 includes P-P interfaces 786 and 788. Processors 770, 780 may exchange information via a point-to-point (P-P) interface 750 using P-P interface circuits 778, 788. As shown in FIG. 7, CL 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation 110 interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

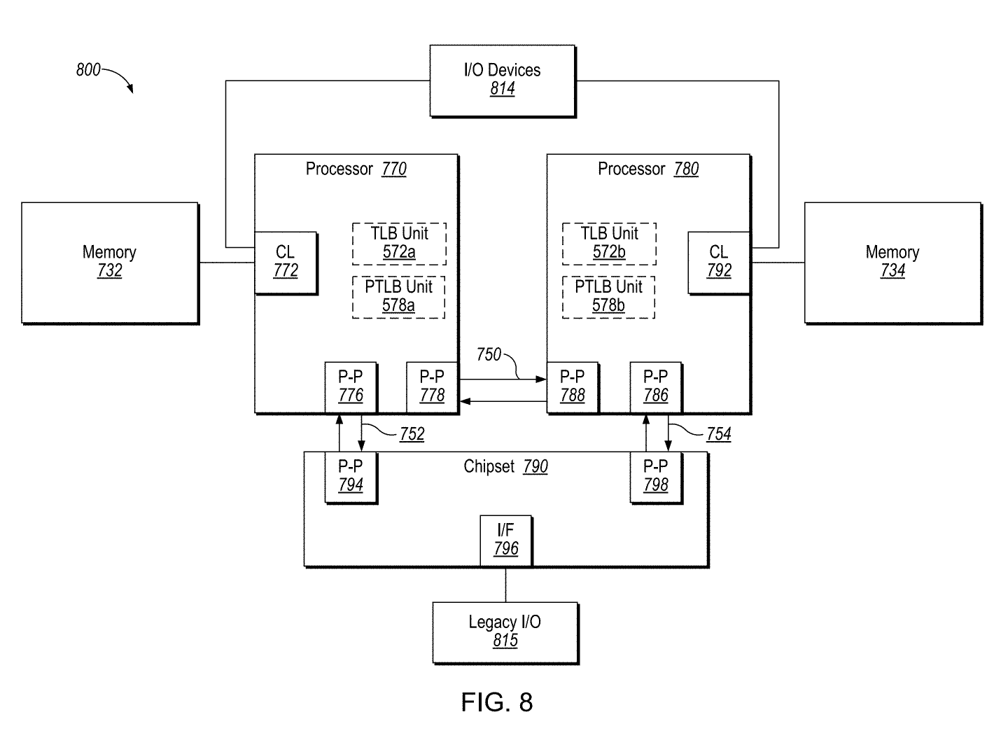

Referring now to FIG. 8, shown is a block diagram of a third system 800 in accordance with an embodiment of the present disclosure. Like elements in FIGS. 7 and 8 bear like reference numerals, and certain aspects of FIG. 7 have been omitted from FIG. 8 in order to avoid obscuring other aspects of FIG. 8.

FIG. 8 illustrates that the processors 770, 780 may include integrated memory and I/O control logic (“CL”) 772 and 782, respectively. For at least one embodiment, the CL 772, 782 may include integrated memory controller units such as described herein. In addition, CL 772, 782 may also include I/O control logic. FIG. 8 illustrates that the memories 732, 734 are coupled to the CL 772, 782, and that I/O devices 814 are also coupled to the control logic 772, 782. Legacy I/O devices 815 are coupled to the chipset 790. The embodiments of the TLB unit 572 and PTLB unit 578 can be implemented in processor 770, processor 780, or both.

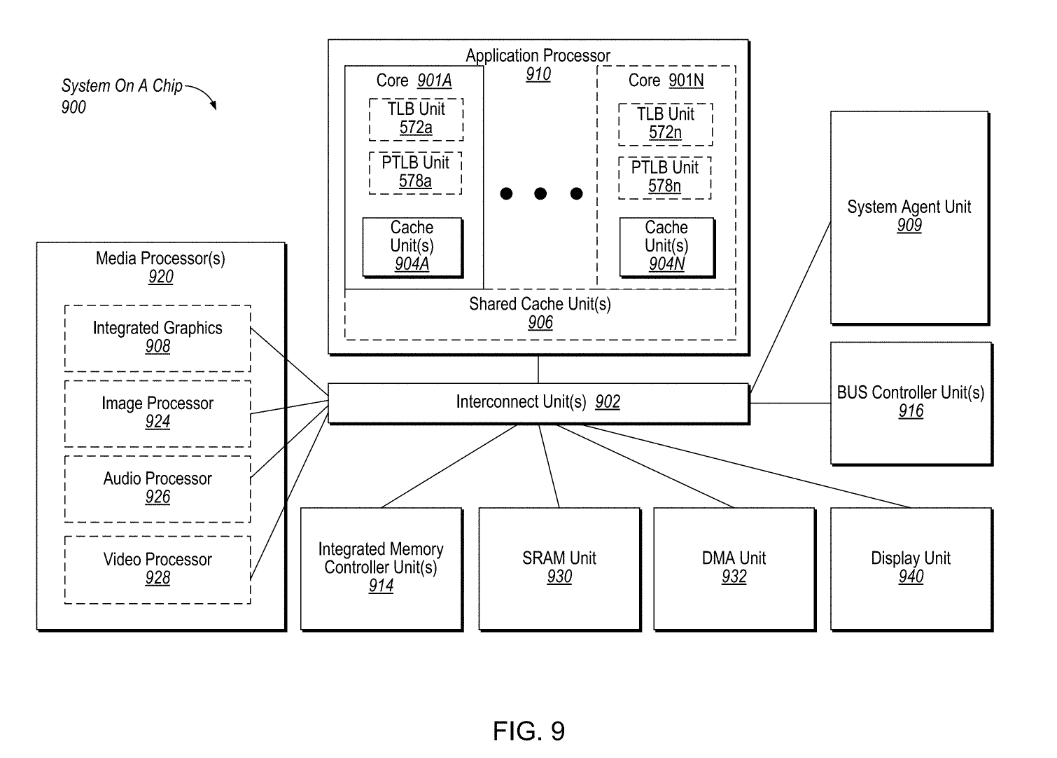

FIG. 9 is an exemplary system on a chip (SoC) that may include one or more of the cores 901 (e.g., processor core 104). Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 9, shown is a block diagram of a SoC 900 in accordance with an embodiment of the present disclosure. Also, dashed lined boxes are features on more advanced SoCs. In FIG. 9, an interconnect unit(s) 902 is coupled to: an application processor 910 which includes a set of one or more cores 901A-N and shared cache unit(s) 906; a system agent unit 909; a bus controller unit(s) 916; an integrated memory controller unit(s) 914; a set or one or more media processors 920 which may include integrated graphics logic 908, an image processor 924 for providing still and/or video camera functionality, an audio processor 926 for providing hardware audio acceleration, and a video processor 928 for providing video encode/decode acceleration; a static random access memory (SRAM) unit 930; a direct memory access (DMA) unit 932; and a display unit 940 for coupling to one or more external displays. The embodiments of the pages additions and content copying can be implemented in SoC 900. TLB unit 572 and PTLB unit 578 may be located in the application processor 910. In one embodiment, TLB unit 572 and PTLB unit 578 are located in one or more of cores 901A to 901N. In another embodiment, TLB unit 572 and PTLB unit 578 are located exterior to and are coupled to one or more of cores 901A to 901N. Each core 901 may be coupled to a corresponding TLB unit 572 and PTLB unit 578 (e.g., core 901A may be coupled to TLB unit 572a and PTLB unit 578a, core 901N may be coupled to TLB unit 572n and PTLB unit 578n, etc.).

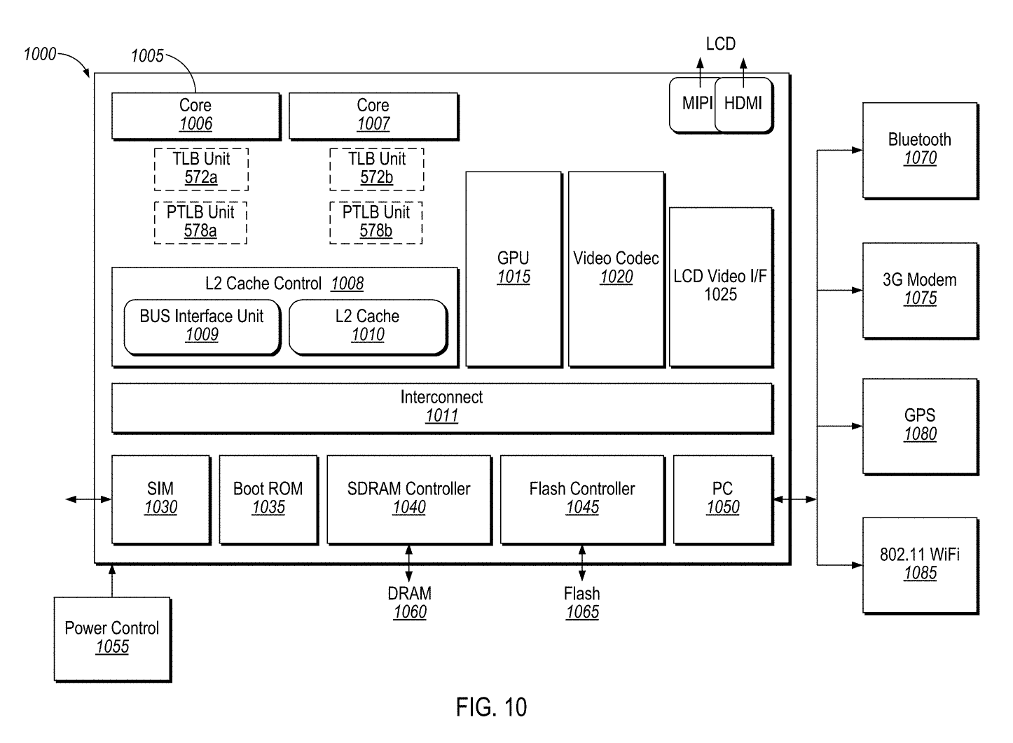

Turning next to FIG. 10, an embodiment of a system on-chip (SoC) design in accordance with embodiments of the disclosure is depicted. As an illustrative example, SoC 1000 is included in user equipment (UE). In one embodiment, UE refers to any device to be used by an end-user to communicate, such as a hand-held phone, smartphone, tablet, ultra-thin notebook, notebook with broadband adapter, or any other similar communication device. A UE may connect to a base station or node, which can correspond in nature to a mobile station (MS) in a GSM network. The embodiments of the TLB unit 572 and PTLB unit 578 can be implemented in SoC 1000.

Here, SoC 1000 includes 2 cores—1006 and 1007. Similar to the discussion above, cores 1006 and 1007 may conform to an Instruction Set Architecture, such as a processor having the Intel® Architecture Core™, an Advanced Micro Devices, Inc. (AMD) processor, a MIPS-based processor, an ARM-based processor design, or a customer thereof, as well as their licensees or adopters. Cores 1006 and 1007 are coupled to cache control 1008 that is associated with bus interface unit 1009 and L2 cache 1010 to communicate with other parts of system 1000. Interconnect 1011 includes an on-chip interconnect, such as an IOSF, AMBA, or other interconnects discussed above, which can implement one or more aspects of the described disclosure.

Interconnect 1011 provides communication channels to the other components, such as a Subscriber Identity Module (SIM) 1030 to interface with a SIM card, a boot ROM 1035 to hold boot code for execution by cores 1006 and 1007 to initialize and boot SoC 1000, a SDRAM controller 1040 to interface with external memory (e.g. DRAM 1060), a flash controller 1045 to interface with non-volatile memory (e.g. Flash 1065), a peripheral control 1050 (e.g. Serial Peripheral Interface) to interface with peripherals, video codecs 1020 and Video interface 1025 to display and receive input (e.g. touch enabled input), GPU 1015 to perform graphics related computations, etc. Any of these interfaces may incorporate aspects of the embodiments described herein.

In addition, the system illustrates peripherals for communication, such as a Bluetooth module 1070, 3G modem 1075, GPS 1080, and Wi-Fi 1085. Note as stated above, a UE includes a radio for communication. As a result, these peripheral communication modules may not all be included. However, in a UE some form of a radio for external communication should be included.

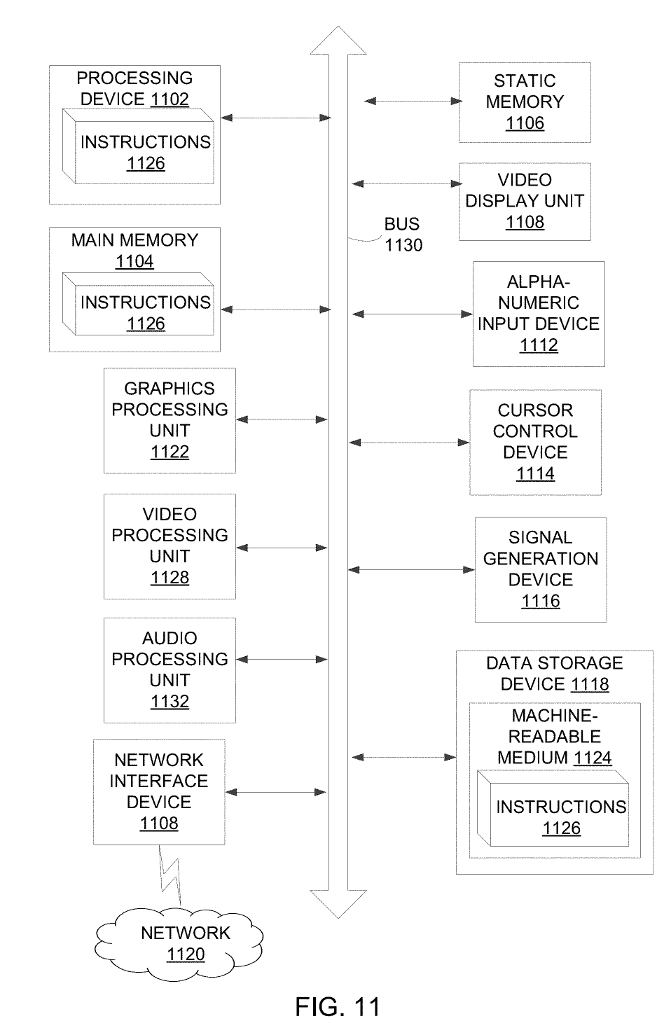

FIG. 11 illustrates a diagrammatic representation of a machine in the example form of a computing system 1100 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The embodiments of the TLB unit 572 and PTLB unit 578 can be implemented in computing system 1100.

The computing system 1100 includes a processing device 1102, main memory 1104 (e.g., read-only memory (ROM), flash memory, dynamic random access memory (DRAM) (such as synchronous DRAM (SDRAM) or DRAM (RDRAM), etc.), a static memory 1106 (e.g., flash memory, static random access memory (SRAM), etc.), and a data storage device 1118, which communicate with each other via a bus 1130.

Processing device 1102 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. In one embodiment, processing device 1102 may include one or processor cores. The processing device 1102 is configured to execute the instructions 1126 (e.g., processing logic) for performing the operations discussed herein. In one embodiment, processing device 1102 can include the PTLB control mechanism 130 and PTLB 132 of FIG. 1A. In another embodiment, processing device 1102 is processor 102 of any of FIGS. 1A-C. Alternatively, the computing system 1100 can include other components as described herein. It should be understood that the core may not support multithreading (e.g., executing two or more parallel sets of operations or threads, time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology)).

The computing system 1100 may further include a network interface device 1108 communicably coupled to a network 1120. The computing system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a signal generation device 1116 (e.g., a speaker), or other peripheral devices. Furthermore, computing system 1100 may include a graphics processing unit 1122, a video processing unit 1128 and an audio processing unit 1132. In another embodiment, the computing system 1100 may include a chipset (not illustrated), which refers to a group of integrated circuits, or chips, that are designed to work with the processing device 1102 and controls communications between the processing device 1102 and external devices. For example, the chipset may be a set of chips on a motherboard that links the processing device 1102 to very high-speed devices, such as main memory 1104 and graphic controllers, as well as linking the processing device 1102 to lower-speed peripheral buses of peripherals, such as USB, PCI or ISA buses.

The data storage device 1118 may include a computer-readable storage medium 1124 on which is stored instructions 1126 (e.g., software) embodying any one or more of the methodologies of functions described herein. The instructions 1126 (e.g., software) may also reside, completely or at least partially, within the main memory 1104 as instructions 1126 and/or within the processing device 1102 as processing logic during execution thereof by the computing system 1100; the main memory 1104 and the processing device 1102 also constituting computer-readable storage media.

The computer-readable storage medium 1124 may also be used to store instructions 1126 utilizing the processing device 1102 and/or a software library containing methods that call the above applications. While the computer-readable storage medium 1124 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the present embodiments. The term “computer-readable storage medium” shall accordingly be taken to include, but not be limited to, solid-state memories, and optical and magnetic media.

The following examples pertain to further embodiments.

Example 1 is a processor comprising: a first translation lookaside buffer (TLB); a second TLB; a TLB control mechanism to: store a TLB-miss count (TMC) for a page, the TMC indicating a number of TLB misses of the first TLB for the page; determine that the TMC is greater than a threshold count; and store a translation of the page in the second TLB responsive to a determination that the TMC is greater than the threshold count.

In Example 2, the subject matter of Example 1, further comprising a first TLB control mechanism to store first translations into the first TLB based on a first policy, wherein the TLB control mechanism is to store second translations into the second TLB based on a second policy that is different from the first policy.

In Example 3, the subject matter of any one of Examples 1-2 further comprising a TLB miss counter coupled to the first TLB control mechanism, the TLB miss counter to increment the TMC responsive to a TLB miss in the first TLB for the page.

In Example 4, the subject matter of any one of Examples 1-3, wherein the TLB control mechanism is to store the threshold count and a minimum TMC of the second TLB, wherein the TLB control mechanism is further to determine that the TMC is greater than the minimum TMC of the second TLB prior to storing the translation in the second TLB.

In Example 5, the subject matter of any one of Examples 1-4, wherein the TLB control mechanism is to: determine that the second TLB does not have at least one free entry; and evict a first entry corresponding to a minimum TMC from the second TLB prior to the TLB control mechanism storing the translation in the second TLB.

In Example 6, the subject matter of any one of Examples 1-5, wherein the TLB control mechanism is to update the threshold count to be greater than the TMC responsive to storing the translation in the second TLB.

In Example 7, the subject matter of any one of Examples 1-6 further comprising a memory management unit (MMU) comprising the first TLB, the second TLB, the TLB control mechanism, and a hash table, wherein a TLB miss counter associated with the TMC for the page is stored in the hash table.

In Example 8, the subject matter of any one of Examples 1-7, wherein a TLB miss counter associated with the TMC for the page is stored in unused bits in a page table entry (PTE) of the second TLB, the PTE corresponding to the translation of the page.

In Example 9, the subject matter of any one of Examples 1-8, wherein a TLB miss counter associated with the TMC for the page is stored in a shadow counter table corresponding to a page table, wherein the translation of the page is stored in a page table entry (PTE) of the page table.

Example 10 is a system comprising: a processor core; a processor memory hierarchy coupled to the processor core; a first translation lookaside buffer (TLB) coupled to the processor core and the processor memory hierarchy; a second TLB coupled to the processor core and the processor memory hierarchy; a TLB control mechanism coupled to second TLB, the TLB control mechanism to: store a TLB-miss count (TMC) for a page, the TMC indicating a number of TLB misses of the first TLB for the page; determine that the TMC is greater than a threshold count; and store a translation of the page in the second TLB responsive to a determination that the TMC is greater than the threshold count.

In Example 11, the subject matter of Example 10 further comprising: a first TLB control mechanism coupled to the first TLB, the first TLB control mechanism to store first translations into the first TLB based on a first policy, wherein the TLB control mechanism is to store second translations into the second TLB based on a second policy that is different from the first policy; and a TLB miss counter coupled to the first TLB control mechanism, the TLB miss counter to increment the TMC responsive to a TLB miss in the first TLB for the page.

In Example 12, the subject matter of any one of Examples 10-11 further comprising a third TLB and a fourth TLB, wherein a first TLB control mechanism coupled to the first TLB stores and evicts translations from the first TLB and the third TLB based on a first policy, wherein the TLB control mechanism stores and evicts translations from the second TLB and the fourth TLB based on a second policy that is different from the first policy.

In Example 13, the subject matter of any one of Examples 10-12 further comprising a memory management unit (MMU) coupled to the processor core and the processor memory hierarchy, wherein the MMU comprises the first TLB, the second TLB, the third TLB, the fourth TLB, the first TLB control mechanism, and the first TLB control mechanism.

In Example 14, the subject matter of any one of Examples 10-13, wherein: the first TLB, the third TLB, and the first TLB control mechanism correspond to a L1-level of the MMU; and the second TLB, the fourth TLB, and the TLB control mechanism correspond to a L2-level of the MMU.

Example 15 is a method comprising: storing, by a second translation lookaside buffer (TLB) control mechanism of a processor, a TLB-miss count (TMC) for a page, the TMC indicating a number of TLB misses of a first TLB of the processor for the page, wherein the TLB control mechanism is associated with a second TLB of the processor; determining, by the TLB control mechanism, that the TMC is greater than a threshold count; and storing, by the TLB control mechanism, a translation of the page in the second TLB responsive to a determination that the TMC is greater than the threshold count.

In Example 16, the subject matter of Example 15 further comprising: storing, by a first TLB control mechanism, first translations into the first TLB based on a first policy, wherein the storing, by the TLB control mechanism, of the translation into the second TLB is based on a second policy that is different from the first policy; and incrementing, by a TLB miss counter for the page coupled to the first TLB control mechanism, the TMC responsive to a TLB miss in the first TLB for the page.

In Example 17, the subject matter of any one of Examples 15-16 further comprising: storing, by the TLB control mechanism, the threshold count and a minimum TMC of the second TLB; and determining, by the TLB control mechanism, that the TMC is greater than the minimum TMC of the second TLB prior to storing the translation in the second TLB.

In Example 18, the subject matter of any one of Examples 15-17 further comprising storing, by the TLB control mechanism, the TMC in the TLB control mechanism responsive to the determination that the TMC is greater than the threshold count and responsive to a second determination that the TMC is greater than the minimum TMC.

In Example 19, the subject matter of any one of Examples 15-18 further comprising: determining, by the TLB control mechanism, that the second TLB does not have at least one free entry; and evicting, by the TLB control mechanism, a first entry corresponding to a minimum TMC from the second TLB, wherein the storing of the translation in the second TLB is subsequent to evicting of the first entry.

In Example 20, the subject matter of any one of Examples 15-19 further comprising updating, by the TLB control mechanism, the threshold count to be greater than the TMC responsive to the storing of the translation in the second TLB.

Example 21 is an apparatus comprising means to perform a method of any one of Examples 15-20.

Example 22 is at least one machine readable medium comprising a plurality of instructions, when executed, to implement a method or realize an apparatus of any one of Examples 15-20.

Example 23 is an apparatus comprising a processor configured to perform the method of any one of Examples 15-20.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

In the description herein, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler embodiments, specific expression of algorithms in code, specific power down and gating techniques/logic and other specific operational details of computer system have not been described in detail in order to avoid unnecessarily obscuring the present disclosure.

The embodiments are described with reference to access control in specific integrated circuits, such as in computing platforms or microprocessors. The embodiments may also be applicable to other types of integrated circuits and programmable logic devices. For example, the disclosed embodiments are not limited to desktop computer systems or portable computers, such as the Intel® Ultrabooks™ computers. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. The disclosed embodiments may especially be used for low-end devices, like wearable devices (e.g., watches), electronic implants, sensory and control infrastructure devices, controllers, supervisory control and data acquisition (SCADA) systems, or the like. Moreover, the apparatuses, methods, and systems described herein are not limited to physical computing devices, but may also relate to software optimizations for energy conservation and efficiency. As will become readily apparent in the description below, the embodiments of methods, apparatuses, and systems described herein (whether in reference to hardware, firmware, software, or a combination thereof) are vital to a ‘green technology’ future balanced with performance considerations.

Although the embodiments herein are described with reference to a processor, other embodiments are applicable to other types of integrated circuits and logic devices. Similar techniques and teachings of embodiments of the present disclosure can be applied to other types of circuits or semiconductor devices that can benefit from higher pipeline throughput and improved performance. The teachings of embodiments of the present disclosure are applicable to any processor or machine that performs data manipulations. However, the present disclosure is not limited to processors or machines that perform 512 bit, 256 bit, 128 bit, 64 bit, 32 bit, or 16 bit data operations and can be applied to any processor and machine in which manipulation or management of data is performed. In addition, the description herein provides examples, and the accompanying drawings show various examples for the purposes of illustration. However, these examples should not be construed in a limiting sense as they are merely intended to provide examples of embodiments of the present disclosure rather than to provide an exhaustive list of all possible embodiments of embodiments of the present disclosure.

Although the below examples describe instruction handling and distribution in the context of execution units and logic circuits, other embodiments of the present disclosure can be accomplished by way of a data or instructions stored on a machine-readable, tangible medium, which when performed by a machine cause the machine to perform functions consistent with at least one embodiment of the disclosure. In one embodiment, functions associated with embodiments of the present disclosure are embodied in machine-executable instructions. The instructions can be used to cause a general-purpose or special-purpose processor that is programmed with the instructions to perform the steps of the present disclosure. Embodiments of the present disclosure may be provided as a computer program product or software which may include a machine or computer-readable medium having stored thereon instructions which may be used to program a computer (or other electronic devices) to perform one or more operations according to embodiments of the present disclosure. Alternatively, operations of embodiments of the present disclosure might be performed by specific hardware components that contain fixed-function logic for performing the operations, or by any combination of programmed computer components and fixed-function hardware components.

Instructions used to program logic to perform embodiments of the disclosure can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “storing,” “determining,” “incrementing,” “evicting,” “updating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

What is claimed is:

1. A processor comprising:
a first translation lookaside buffer (TLB);
a second TLB;
a TLB control mechanism to:
store a TLB-miss count (TMC) for a page, the TMC indicating a number of TLB misses of the first TLB for the page;
determine that the TMC is greater than a threshold count; and
store a translation of the page in the second TLB responsive to a determination that the TMC is greater than the threshold count.

2. The processor of claim 1 further comprising a first TLB control mechanism to store first translations into the first TLB based on a first policy, wherein the TLB control mechanism is to store second translations into the second TLB based on a second policy that is different from the first policy.

3. The processor of claim 2 further comprising a TLB miss counter coupled to the first TLB control mechanism, the TLB miss counter to increment the TMC responsive to a TLB miss in the first TLB for the page.

4. The processor of claim 1, wherein the TLB control mechanism is to store the threshold count and a minimum TMC of the second TLB, wherein the TLB control mechanism is further to determine that the TMC is greater than the minimum TMC of the second TLB prior to storing the translation in the second TLB.

5. The processor of claim 1, wherein the TLB control mechanism is to:
determine that the second TLB does not have at least one free entry; and
evict a first entry corresponding to a minimum TMC from the second TLB prior to the TLB control mechanism storing the translation in the second TLB.

6. The processor of claim 1, wherein the TLB control mechanism is to update the threshold count to be greater than the TMC responsive to storing the translation in the second TLB.

7. The processor of claim 1 further comprising a memory management unit (MMU) comprising the first TLB, the second TLB, the TLB control mechanism, and a hash table, wherein a TLB miss counter associated with the TMC for the page is stored in the hash table.

8. The processor of claim 1, wherein a TLB miss counter associated with the TMC for the page is stored in unused bits in a page table entry (PTE) of the second TLB, the PTE corresponding to the translation of the page.

9. The processor of claim 1, wherein a TLB miss counter associated with the TMC for the page is stored in a shadow counter table corresponding to a page table, wherein the translation of the page is stored in a page table entry (PTE) of the page table.

10. A system comprising:
a processor core;
a processor memory hierarchy coupled to the processor core;
a first translation lookaside buffer (TLB) coupled to the processor core and the processor memory hierarchy;
a second TLB coupled to the processor core and the processor memory hierarchy;
a TLB control mechanism coupled to second TLB, the TLB control mechanism to:
store a TLB-miss count (TMC) for a page, the TMC indicating a number of TLB misses of the first TLB for the page;
determine that the TMC is greater than a threshold count; and
store a translation of the page in the second TLB responsive to a determination that the TMC is greater than the threshold count.

11. The system of claim 10 further comprising:
a first TLB control mechanism coupled to the first TLB, the first TLB control mechanism to store first translations into the first TLB based on a first policy, wherein the TLB control mechanism is to store second translations into the second TLB based on a second policy that is different from the first policy; and
a TLB miss counter coupled to the first TLB control mechanism, the TLB miss counter to increment the TMC responsive to a TLB miss in the first TLB for the page.

12. The system of claim 10 further comprising a third TLB and a fourth TLB, wherein a first TLB control mechanism coupled to the first TLB stores and evicts translations from the first TLB and the third TLB based on a first policy, wherein the TLB control mechanism stores and evicts translations from the second TLB and the fourth TLB based on a second policy that is different from the first policy.

13. The system of claim 12 further comprising a memory management unit (MMU) coupled to the processor core and the processor memory hierarchy, wherein the MMU comprises the first TLB, the second TLB, the third TLB, the fourth TLB, the first TLB control mechanism, and the first TLB control mechanism.

14. The system of claim 13, wherein:
the first TLB, the third TLB, and the first TLB control mechanism correspond to a L1-level of the MMU; and
the second TLB, the fourth TLB, and the TLB control mechanism correspond to a L2-level of the MMU.

15. A method comprising:
storing, by a second translation lookaside buffer (TLB) control mechanism of a processor, a TLB-miss count (TMC) for a page, the TMC indicating a number of TLB misses of a first TLB of the processor for the page, wherein the TLB control mechanism is associated with a second TLB of the processor;
determining, by the TLB control mechanism, that the TMC is greater than a threshold count; and
storing, by the TLB control mechanism, a translation of the page in the second TLB responsive to a determination that the TMC is greater than the threshold count.

16. The method of claim 15 further comprising:
storing, by a first TLB control mechanism, first translations into the first TLB based on a first policy, wherein the storing, by the TLB control mechanism, of the translation into the second TLB is based on a second policy that is different from the first policy; and
incrementing, by a TLB miss counter for the page coupled to the first TLB control mechanism, the TMC responsive to a TLB miss in the first TLB for the page.

17. The method of claim 15 further comprising:
storing, by the TLB control mechanism, the threshold count and a minimum TMC of the second TLB; and
determining, by the TLB control mechanism, that the TMC is greater than the minimum TMC of the second TLB prior to storing the translation in the second TLB.

18. The method of claim 17 further comprising storing, by the TLB control mechanism, the TMC in the TLB control mechanism responsive to the determination that the TMC is greater than the threshold count and responsive to a second determination that the TMC is greater than the minimum TMC.

19. The method of claim 15 further comprising:
determining, by the TLB control mechanism, that the second TLB does not have at least one free entry; and
evicting, by the TLB control mechanism, a first entry corresponding to a minimum TMC from the second TLB, wherein the storing of the translation in the second TLB is subsequent to evicting of the first entry.

20. The method of claim 15 further comprising updating, by the TLB control mechanism, the threshold count to be greater than the TMC responsive to the storing of the translation in the second TLB.
